(19) United States
(12) Patent Application Publication
(10) Pub. No.: US 2009/0206084 A1
(43) Pub. Date: Aug. 20, 2009

(54) PROGRAMMABLE LIQUID CONTAINERS

(75) Inventors: Tod M. Woolf, Sudbury, MA (US); Andrew S. Marks, Wayland, MA (US); Glenn Wachler, Boca Raton, FL (US); Scott Woolf, West Bloomfield, MI (US)

Correspondence Address: LAHIVE & COCKFIELD, LLP;FLOOR 30, SUITE 3000, ONE POST OFFICE SQUARE, BOSTON, MA, 02109, US

(73) Assignee: IPIFINI, Inc., Sudbury, MA (US)

(21) Appl. No.: 11/913,018

(22) PCT Filed: Mar. 24, 2006
(86) PCT No.: PCT/US06/10878

§ 371 Date: Nov. 5, 2008

Related U.S. Application Data
(60) Provisional application No. 60/594,704, filed on Apr. 29, 2005.

(51) Int. Cl. B65D 25/02; A23L 1/221; A23L 1/30; A23C 13/12; A23F 3/14; A23F 5/00; A23L 2/40; C11B 5/00

(52) U.S. Cl. 220/500; 426/650; 426/648; 426/586; 426/597; 426/594; 426/591; 426/541; 156/145

(57) ABSTRACT

The invention relates to liquid containers comprising a plurality of sealed additive chambers in communication with a vessel tillable with a liquid. The additive chambers comprise independently selected additives that may be added to a liquid in the container at the option of the user. The user can manually open the additive chambers of their choice and release the additive into a liquid in the vessel without destroying the integrity of the container. In this manner, the liquid containers are programmable by the users and various aspects of the liquid in the container, such as color and/or flavor, is controlled by the user.

### RELATED APPLICATION INFORMATION

This application claims priority to and the benefit of a United States Provisional application entitled “Programmable Liquid Containers”, filed Apr. 29, 2005, Application No. 60/594,704.

### TECHNICAL FIELD OF THE INVENTION

The invention relates to liquid containers comprising a plurality of sealed additive chambers in communication with a vessel fillable with a liquid. The additive chambers comprise independently selected additives that may be added to a liquid in the container at the option of the user. The user can manually open the additive chambers of their choice and release the additive into a liquid in the vessel without destroying the integrity of the container. In this manner, the liquid containers are programmable by the users and various aspects of the liquid in the container, such as color and/or flavor, is controlled by the user.

### BACKGROUND OF THE INVENTION

The beginning of the twenty-first century has seen a trend toward the personalization of many consumer items. Advances in manufacturing technology and the decreasing cost of incorporating technological advances into consumer products has provided consumers with a wide array of choices both in the variety of items available and in control over the use of those items. Further advances that provide consumers with greater control over choices in consumer products are desirable.

The ever-increasing variety of products available to consumers has placed a strain on retailers in terms of shelf space available to display these items to the public. This, in turn, reduces the exposure of a product and may result in decreased sales of the product, as well as decreased overall sales for the retailer. Moreover, the increasing availability of closely related liquids, especially beverages, from the same manufacturer has added cost and complexity to both manufacturing. It has also created stocking problems for the manufacturer (inventory) and the consumer, in addition to the retailer. The ability to simplify and lower the cost of manufacturing, as well as reducing storage space requirements at all levels of the product chain, while still offering a full variety of products would be highly beneficial.

A number of inventions have been made that relate to storing an additive separately from a liquid. For example, U.S. Pat. No. 6,705,490 describes a cap for attaching to a beverage container comprising a chamber containing an additive. The chamber has a first and a second closure that keep the additive in the chamber. When the closure at the bottom end of the chamber is opened, the additive flows into a beverage in the container.

U.S. Pat. No. 6,372,270 describes a cap for a water bottle that comprises a powdered drink mix or a tea bag in a sealed containment chamber. The chamber is closed by the lower end of a plunger at its top and by a burstable seal at its bottom. When the user pushes downward on the cap the plunger is depressed, the seal is broken and the contents of the sealed containment chamber are released into the bottle.

U.S. Pat. No. 6,170,654 describes a closure cap comprising therein a blister pack containing an additive. The blister pack is ruptured simultaneously with the opening of the closure pack through the action of a central pillar. The central pillar pushes down on the blister pack as the cap is opened, thereby forcing the contents from the blister pack.

U.S. Pat. No. 6,165,523 describes a bottle cap for attaching to a mouth portion of a bottle. The cap comprises flavor enhancers stored in a transparent bellows attached to the cap. The bellows optionally comprise a plunger affixed to the top of the bellows. The bottom of the bellows is sealed with an impermeable membrane. Depression of the bellows or the plunger exerts pressure on the membrane, which tears away and releases the enhancers from the bellows.

U.S. Pat. No. 5,884,759 describes a device enabling the separate storage of two or more components to be mixed together and the mixture to be dispensed. The device comprises a receptacle and inside the receptacle two chambers separated by a shutter. The device further includes a pushbutton for removing or tearing the shutter thereby putting the two chambers into communication with one another.

U.S. Pat. No. 5,866,185 describes an impermeable tubular dispensing device comprising a soluble or dispersible material. The device has perforations along a portion of its length so that when immersed in a liquid the material within the tube disperses into the liquid.

U.S. Pat. No. 5,692,644 describes a container consisting of two separate reservoirs, one for a powdered substance and one for a liquid substance, separated by a movable wall. A pusher-driven piston that forces a cutting edge through the wall causes the substances to mix.

U.S. Pat. No. 5,431,276 describes an attachable lid for dispensing additives into a cup. The lid has a plurality of compartments that contain additives. Each compartment has a plunger that is capable of puncturing the bottom of the compartment and dispensing the additives into the cup.

U.S. Pat. No. 6,293,433 describes a device for dispensing a mixture of two or more components stored in separate compartment kept sealed from one another by a stopper member prior to dispensing the mixture. An actuator moves the stopper from a storage position where the compartments are separated to a mixing position where the compartments are in a flow communication with one another.

U.S. Pat. No. 6,305,576 describes a container for dispensing and mixing at least two components in aseptic manner. The container holds a first fluid and further comprises a sealed cartridge containing a second fluid. The cartridge comprises a movable member capable of breaking the cartridge seal and releasing the second fluid into the first fluid.

U.S. Pat. No. 6,224,922 describes a beverage container with a multiple colorant reservoir built into the cap. The reservoir has a number of colorant chambers for the colorants, any of which can be released into the beverage by the user to achieve the desired hue and intensity of the beverage. The colorant chambers open into a common central cylinder through a small valve opening. The contents of the chamber are released drop by drop when the valve opening is aligned with an opening in a valve tube seated in the central cylinder.

United States Published Application No. 20020157971 describes a cap for use with a container that includes a ring member having an opening and a capsule provided on the ring member. A plunger is provided on an interior wall of the capsule. The capsule contains a substance, such as a liquid flavorant. The container has a main chamber filled with a beverage. When the cap is placed on the container, the plunger can be actuated to break the capsule and disperse the liquid therein into the beverage.

Despite the advancements to date, there is still a need for liquid containers that allow manufacturers to offer multiple versions of a liquid product in a single container.

### SUMMARY OF THE INVENTION

The present invention solves the problem set forth above by providing a programmable liquid container comprising a vessel having a main chamber fillable with a base liquid, an inner vessel surface in physical communication with said main chamber, an outer vessel surface, and a sealable outlet for said liquid; and a plurality of sealed additive chambers each comprising an independently selected additive, each additive chamber having an inner chamber surface and an outer chamber surface. The outer additive chamber surface is in physical communication with said vessel; and the additive chamber is manually openable by a user when said vessel is filled with a base liquid and said outlet is sealed.

In one embodiment, the outlet must be initially unsealed to release pressure within the chamber before an additive chamber can be manually opened by a user. In this embodiment the outlet may be resealed by the user prior to opening an additive chamber.

In another embodiment, the container comprises a plurality of outlets, wherein each outlet is in communication with an additive chamber and wherein at least one outlet must be opened in order for the user to have access to an additive chamber, while the other outlets may remained sealed. In a preferred aspect of this embodiment, the outlet is opened with a device comprising a piercing end. That device, when inserted into the vessel through a chosen outlet also opens an additive chamber in communication with said outlet and allows the base liquid to mix with the additive in the opened chamber.

When the user opens an additive chamber the one or more additives contained inside is placed in communication with the base liquid prior to said base liquid exiting said outlet. This results in a mixing of the additive and the base liquid. The opening of the additive chamber does not disrupt the integrity of the sealed vessel. Thus, no liquid can leave the container until the user unseals the outlet.

The term “base” as used herein means a liquid comprising at least some of the components necessary for the liquid to be useful for its intended purpose. With respect to edible liquids, the base liquid may be water. In some embodiments, the base liquid will not be useful for its intended purpose until it has been mixed with at least one additive. In other embodiments the base liquid will be useful without the addition of additives, but its use will be enhanced aesthetically and/or functionally or modified when it is mixed with one of more additives. Throughout the application the term “base liquid” and “liquid” are used interchangeably. It should be understood that any general reference to a “liquid” or specific reference to particular type of liquid present in the vessel portion of the containers disclosed herein to which an additive has not yet been added is a reference to a base liquid.

In each of the above embodiments the liquid may be an edible base liquid such as water, juice, soda, milk, coffee, tea and the like. Other edible base liquids useful in this invention include sauce bases, dressing bases, marinade bases, soup bases (e.g., broths), etc. When the liquid is an edible base liquid, the plurality of additive chambers comprises additives independently selected from a colorant, a flavoring, a sweetener, a pharmaceutical, a nutrient, a creamer, tea, coffee, an agent to promote mixing of said liquid and said additive, a carbonating agent or a preservative.

Alternatively, the liquid may be a biological fluid to be administered intravenously to a subject or a growth media for cells. In yet another embodiment, the liquid may be a non-edible household product, such as a paint base, a cleaning fluid base, an emollient or lotion base, a hair or fabric dye base, a cosmetic base, a disinfectant base, a fertilizer base, or a pesticide base. In these embodiments, the plurality of additive chambers comprises additives selected from groups appropriate to the liquid. Such additives are disclosed in detail below.

In another embodiment, the container additionally comprises a sealing device for sealing the outlet. In this embodiment, the outer surface of the additive chamber is in communication with the sealing device. When the liquid is an edible liquid in this embodiment and one of said additive chambers comprises an additive that is a colorant, at least one other of said additive chambers comprises an additive other than a colorant.

In an alternative embodiment, the containers described above may additionally comprise within the vessel a mixing chamber located between the main vessel chamber and the outlet. The additives are released into the mixing chamber. Base liquid in the main chamber flows unidirectionally into the mixing chamber where it can be mixed with the released additives. Any base liquid or additive or mixture thereof cannot flow back into the main vessel chamber. This alternate embodiment of a container of this invention allows multiple uses of the base liquid in the main chamber, wherein for each use a different additive or combination of additives may be mixed with an aliquot of the liquid present in the mixing chamber.

In yet another aspect, the invention provides a disposable liquid container comprising a vessel having a main chamber tillable with a base liquid and an inner vessel surface in physical communication with said main chamber. In this embodiment, at least a portion of the inner vessel surface is coated with an additive that is soluble in the base liquid that may fill the chamber. The additive is selected from one or more additives including, but not limited to, a colorant, a flavoring, a sweetener, a pharmaceutical, a nutrient, a creamer, tea, coffee, or an agent to promote mixing of said liquid. The coating of the inner vessel surface is such that a base liquid placed in the main chamber will be in contact with the additive.

In still another aspect of the invention a disposable utensil intended to be brought into communication with a base liquid is provided. The utensil comprises an outer surface that is coated with an additive selected from a colorant, a flavoring, a sweetener, a pharmaceutical, a nutrient, a creamer, tea, coffee, wherein the additive is soluble in said liquid. In a preferred embodiment, the utensil consists of edible materials that are completely soluble in the base liquid; The edible materials may consist of one or more of said additives.

In another embodiment, the invention provides a plurality of additives associated with one another in a single composition of matter. In this embodiment, the plurality of additives comprises at least three additives selected mutually exclusive from one another from a colorant, a flavoring, a sweetener, a pharmaceutical, a nutrient, a creamer, tea, coffee, an agent to promote mixing of said liquid and said additive, a carbonating agent or a preservative. Each individual additive present in this composition of matter is manually separable from another by a user.

In yet another embodiment, the containers of this invention may additionally comprise an LCD display, a temperature indicator, a heating or cooling device or an indicator of which additives and/or how much of each additive has been opened into said man vessel chamber.

In another aspect, the containers of this invention may comprise a structure for facilitating the mixing of said liquid and any of said additives in communication with the liquid. Preferably such structures are integrated into the main chamber or are in permanent communication with the vessel inner surface, such that they cannot be released from the container with the liquid through the outlet.

In yet another embodiment, the sealed additive chambers are arranged in a grid-like array, preferably on the outer surface of the vessel. The grid-like array and the resulting pattern of opened and unopened additive chambers selected by the user is easily remembered. In this manner it provides easy repeatability of the same additive/liquid mixture from one container to another filled with the same liquid and containing the same plurality of additive chambers.

In another aspect, the invention provides a personalized beverage vending machine. The vending machine of the invention comprises storage space for a plurality of bottles filled with the same base liquid; and storage space for a plurality of separately packaged additives. The vending machine further comprises selection means to allow a user to choose at least one of said additives in a single purchase, wherein upon said purchase and the selection of an additive by a user, the machine vends a bottle of the base liquid and the at least one selected additive package. Preferably the number of each potential choice of separately packaged additives stored in the vending machine is equal to the number of bottles stored in the machine. Such a vending machine advantageously reduces or eliminates the possibility that any one combination of liquid/additive will be unavailable for purchase as long as at least one filled bottle is stored in said machine.

The machine is placed in operation by stocking said machine with a plurality of bottles filled with the same base liquid; stocking said vending machine with a plurality of separately packaged additives said plurality comprising at least four individually packaged flavoring additives; and offering for sale from said vending machine in a single purchase a bottle of said base liquid and a choice of one of said flavoring additive packages.

In still another aspect, the invention provides a kit consisting essentially of at least one container filled with an edible base liquid; a plurality of additives to be added to the base liquid and associated with or attached to one another in a single composition of matter, wherein said plurality of additives comprises at least three additives selected mutually exclusive from one another from a colorant, a flavoring, a sweetener, a pharmaceutical, a nutrient, a creamer, tea, coffee, an agent to promote mixing of said liquid and said additive, a carbonating agent or a preservative; and each additive is manually separable from another by a user; and a holder for holding said container and said plurality of additives together in a single portable package. The kit provides the user with the option of adding one or more additives to the base liquid to produce a personalized drink of the user's choice.

### BRIEF DESCRIPTION OF THE DRAWINGS

FIG. 1 depicts a side, cross-sectional view of one embodiment of a container of this invention.

FIG. 2 depicts a side, cross-sectional view of another embodiment of a container of this invention.

FIG. 3 depicts a side, cross-sectional view of another embodiment of a container of this invention.

FIG. 4 depicts a side, cross-sectional view of another embodiment of a container of this invention.

FIG. 5 depicts a side, cross-sectional view of another embodiment of a container of this invention.

FIG. 6 depicts another embodiment of a container of this invention.

FIG. 7 depicts a side, cross-sectional view of another embodiment of a container of this invention.

FIG. 8 depicts two side, cross-sectional views of another embodiment of a container of this invention.

FIG. 9 depicts several views of the manufacture of another a container of this invention.

FIG. 10 depicts a three-dimensional rendering of another embodiment of a container of this invention.

FIG. 11 depicts another embodiment of a container of this invention.

FIG. 12 depicts another embodiment of a container of this invention.

FIG. 13 a three-dimensional rendering of another embodiment of a container of this invention.

FIG. 14 depicts another embodiment of a container of this invention.

FIG. 15 depicts another embodiment of a container of this invention.

FIG. 16 depicts several views of another embodiment of a container of this invention.

FIG. 17 depicts a side, cross-sectional view of another embodiment of a container of this invention.

FIG. 18 depicts another embodiment of a container of this invention.

FIG. 19 depicts another embodiment of a container of this invention.

FIG. 20 depicts a three-dimensional rendering of another container of this invention.

FIG. 21 depicts another embodiment of a container of this invention.

FIG. 22 depicts another embodiment of a container of this invention.

FIG. 23 depicts a three-dimensional rendering of another container of this invention.

FIG. 24 depicts another embodiment of a container of this invention.

FIG. 25 depicts another embodiment of a container of this invention.

FIG. 26A-26B depicts certain specific embodiments of a container of this invention.

FIG. 27 depicts the design of a specific embodiment of a container of this invention.

FIG. 28 depicts another embodiment of a container of this invention.

FIG. 29 depicts another embodiment of a container of this invention.

FIG. 30 depicts a method of manufacture of a container of this invention.

FIG. 31 depicts another method of manufacture of a container of this invention.

FIG. 32 depicts another method of manufacture of a container of this invention.

### DETAILED DESCRIPTION OF THE INVENTION

In a first aspect, the invention provides a programmable liquid container comprising:

a vessel having a main chamber tillable with a base liquid, an inner vessel surface in physical communication with said main chamber, an outer vessel surface, and a sealable outlet for said liquid;

a plurality of sealed additive chambers each comprising an independently selected additive, each additive chamber having an inner chamber surface and an outer chamber surface, wherein:

said outer additive chamber surface is in physical communication with said vessel; and

said additive chamber is manually openable by a user when said vessel is filled with a base liquid and said outlet is sealed, wherein opening an additive chamber places any additive contained therein in communication with said base liquid prior to said base liquid exiting said outlet and does not disrupt the integrity of the sealed vessel.

The vessel component of the liquid container of this invention may be made from numerous materials for storing liquids. The vessel material and in particular the inner vessel surface, should be compatible with the liquid to be stored in the vessel. It should not react with the liquid, e.g., it should not be soluble in the liquid or chemically alter the liquid. Furthermore, for edible liquids, the inner vessel surface material should not impart any flavoring or odor to the liquid. The choice of material for the vessel will also depend upon the temperature of the liquid to be placed in the main chamber. For example, if the liquid is a hot liquid, such as tea, coffee, hot water or soup, the vessel should be composed of one or more materials that retain heat, such as polystyrene. The vessel may also be composed of a plurality of materials, for example the inner wall may be composed of a first material or combination of materials, the outer wall of a second material or combination of materials and the layers in between of yet a third material or combination of materials. Examples of materials that may be used to make the vessel utilized in the containers of this invention include, but are not limited to, natural and artificial polymers such as polyethylene terephthalate (PET), polypropylene, polystyrene, polyvinyl chloride, low-density polyethylene (LDPE), high-density polyethylene (HDPE), poly(oxy-1,2-ethanediyloxycarbonyl-2,6-naphthalenediylcarbonyl (PEN) resins, and other plastics; metals, such as aluminum, steel, and other alloys; glass; flexible foil laminates; high barrier laminated films; cardboard or other paperboard including waxed version thereof, natural fiber, or ceramic.

The list below sets forth some of the preferred types of vessels useful in the containers of this invention:

Bottle

Squeeze Bottle

Aerosol Spray Can

Spray Bottle

Jar

Bowl

Cup

Beverage Box (“juice box”)

Metallic beverage bag (e.g., Capri Sun®)

Sealed plastic Bag Container

Pre-loaded Syringe

Carton

Sealed Tube

Polymer Jug

Drug Delivery Patch

Tube

Vial

I.V. bag

The main chamber of the container of this invention is fillable with a liquid. The main chamber should have a volume compatible with the number of times the container is designed to be used. Thus, for single use containers (e.g., single serving size portions of edible liquids), the volume of the main chamber should be between 3 and 32 ounces). For multiple use containers, the main chamber may be larger in volume, for example up to a gallon. For an edible liquid, the volume of the main chamber is between 6 and 200 ounces.

The vessel also comprises a sealable outlet for removing the liquid from said container. The outlet is typically an opening at the top of the container and is sealable by screw cap, bottle cap, lid, flip-top or other metal can-type opening means, removable plastic, foil or paper seal. The outlet may also be a spray nozzle that is typically sealable by a user-controlled closure, such as a diaphragm. In certain embodiments, the vessel will comprise a plurality of sealable outlets. In such embodiments, access to an additive chamber may require opening one or more of said outlets, while other outlets on the vessel remain sealed. The opened outlets are optionally resealable after the additive chamber has been opened and the additive brought into contact with the base liquid.

The liquid that may fill the container may be an edible liquid, a inedible household product, a fluid intended to be administered intravenously to a subject, a cosmetic, an emollient, a medicament or pharmaceutical, a cell growth media or any other liquid set forth in the list below.

Examples of edible liquids include, but are not limited to, water, carbonated water, a juice, a fruit drink, a sports drink, or a carbonated drink, a liquid dairy product, a tea, an alcoholic beverage, a coffee drink or beverage, a baby formula, a soup or a broth, a sauce, a syrup, a marinade, a condiment, an oil, a vinegar or a dressing. More specifically, the edible liquid may be selected from a flavored soft drink base, such as a cola base, a lemon-lime base, an orange base, a root beer base or a ginger ale base; a natural or artificial juice base, such as apple juice, orange juice, grapefruit juice, berry juice, cranberry juice, grape juice, lemonade, limeade, or fruit punch; purified water including reverse osmosis purified water, filtered water, natural spring mineral water including low mineral and high mineral natural spring water (e.g. Poland Spring Water); a wine cooler, a mixed drink cooler, a beer or other malt beverage, a wine, a spirit including gin, vodka, scotch, rye; tap water; a chicken broth, a beef broth, a vegetable broth; a flavored or unflavored milk, skim milk, fat-free milk, cream, buttermilk; a coffee preferably decaffeinated, a tea preferably decaffeinated or herbal such as Chamomile, mint, lemon, rose hip, etc.; a soy-based baby formula, a milk-based baby formula; ketchup, mustard, mayonnaise; salad dressing; barbecue sauce, tomato sauce, soy sauce, Worcestershire sauce, hot pepper sauce; olive oil, salad oil (e.g., canola oil, vegetable oil, etc.), wine vinegar, apple cider vinegar, rice vinegar, balsamic vinegar, or white vinegar.

In a more preferred embodiment, the liquid is a flavored soft drink. Even more preferred is a cola. Most preferred is a diet cola.

Examples of inedible household liquids include, but are not limited to, paint, a detergent or cleaning agent, an antiseptic, an air freshener, a pesticide, a fertilizer, a plant food, or a clothing dye.

Examples of liquids that are intended to be administered intravenously to a subject include, but are not limited to, blood, plasma, dextrose, glucose, a sodium chloride solution, or sterile water. The term “subject” as used herein includes all mammals, especially humans.

Examples of cosmetic liquids include, but are not limited to perfumes and colognes, nail polish, lip gloss, make-up, eye liner, hair coloring, deodorant, or artificial suntan cream.

Examples of an emollient include, but are not limited to, lotions such as suntan lotion and skin lotion, creams such as hand cream.

Example of a medicament or pharmaceutical liquid include, but are not limited to, a cough syrup, a cold remedy, an analgesic, or a pharmaceutically acceptable liquid carrier, such as a syrup, an ethanol and water mixture or an aqueous liquid base.

Examples of a cell growth media include, but are not limited to, Minimal Essential Media (MEM) and variants thereof, LB broth, yeast growth broth and other cell culture growth liquids known in the art.

The list set forth below lists some of the preferred categories and subcategories of liquid bases that may be utilized in the containers of this invention:

MEDICAL BASE LIQUID

Syrup medical base liquid

Ethanol/water medical base liquid

Aqueous medical base liquid

Cold Remedy

Pain Reliever

HERBAL REMEDY OR HERBAL SUPPLEMENT BASE LIQUID

BABY FORMULA BASE LIQUID

DERMAL COSMETIC BASE LIQUID

Cream

Lotion

Liquid soap

Alcohol containing

Make-up base liquid

Sun block

Skin Lotion

Mosquito Repellant container

Shaving cream, gel or foam

PERFUME BASE LIQUID

PAINT BASE LIQUID

White Paint Base

Clear Paint Base

INK BASE LIQUID

FUEL BASE LIQUID

gasoline

diesel gas

Ethanol

Kerosene

VITAMIN AND MINERAL SUPPLEMENT BASE LIQUID

ENERGY DRINK BASE LIQUID (e.g. boost)

DIET MEAL DRINK BASE LIQUID (e.g. Slimfast®)

Drinking Water Base Liquid

Mineral Water

Tap Water

Carbonated Water

HAIR CARE PRODUCT BASE LIQUID

Hair Coloring base liquids

Shampoo

Hair Conditioner

FLAVORED DRINKING BASE LIQUID

Coffee

Tea

Soft Drinks

Wine Cooler

Spirits

Juice

Sweetened flavored Water Beverage

Sports Drink (e.g. Gatorade®)

Milk

Milk Substitute

Vegetable Juice

LIQUID BASE FOODS

Soup

Yogurt

Freezer Pops

Tomato Sauce

Salsa

LIQUID AIR FRESHENER BASE LIQUID

UNDERARM DEODORANT AND/OR ANTIPERSPIRANT BASE LIQUID

CELL GROWTH MEDIA BASE LIQUID

Dulbecco's Phosphate Buffered Saline (D-PBS) cell culture media

Hank's Balanced Salt Solution (HBSS) cell culture media

DMEM cell culture media

Ham's Nutrient Mixtures cell culture media

IMDM cell culture media

L-15 cell culture media

McCoy's cell culture media

M-199 cell culture media

MEM cell culture media

RPMI 1640 cell culture media

PBS cell culture media

BIOCHEMICAL RESEARCH REAGENT BASE LIQUID

DIAGNOSTIC REAGENT BASE LIQUID

INTRAVENOUS INFUSION BASE LIQUID

In certain embodiments of the present invention, the container is sterilely filled with a liquid and sealed. This is particularly useful when the liquid is a medicament or pharmaceutical, a cell growth media, a liquid intended to be administered intravenously to a subject or an edible liquid, particularly one intended for ingestion by an infant, such as a baby formula.

The containers of the present invention comprise a plurality of sealed additive chambers associated with the vessel. This plurality of additive chambers provides the user of the container with a choice of additives to add to the liquid. The nature of the additive chambers is such that they can be individually and manually opened by the user even when the vessel is filled with liquid and at least one of the outlets of the vessel is sealed. Upon opening of an additive container, the additive is brought into contact with the liquid in the vessel prior to the liquid exiting the outlet. Moreover, the opening of an additive chamber does not destroy the integrity of the sealed vessel. In other words, neither the liquid in the sealed vessel, nor the released additive will leak out of the container upon the opening of the additive chamber.

The sealed additive chamber comprises an outer surface and an inner surface. The additive present in the chamber is in communication with the inner surface prior to the opening of the chamber. The outer surface of the chamber is in physical communication with the vessel.

In one preferred embodiment, the outer surface of the additive chamber is in communication with the inner vessel surface and the main chamber. In this embodiment, only the seal on the chamber need be broken for the additive to be released into the liquid.

In an alternate embodiment, the outer surface of the additive chamber is only in communication with the outer vessel surface. In this embodiment, the seal on the chamber must be broken and, the inner vessel surface must be breached in order to place the additive in communication with the liquid. These events preferably occur simultaneously or as a result of a single action by the user so as to ensure that additive being released from the chamber is placed inside the vessel. In a preferred version of this embodiment the additive chamber additionally comprises a piercing device inside the chamber that opens the chamber and then penetrates the inner surface. In another preferred embodiment, the portion of the inner wall that is required to be breached is made of an easily pierceable material

It will be readily apparent that the additive chamber and the vessel may share a common surface. For example, a portion of both the outer and inner surface of the vessel may serve as the inner and outer surface of the additive chamber, respectively. One example of this is a frangible septum separating the additive chamber from the vessel. The opening of the additive chamber (i.e., the breaking of the septum) will cause the formation of an opening in the vessel wall allowing the contents of the additive chamber to be released into the vessel.

In yet another embodiment, the vessel comprises an aperture and the additive chamber is placed over the aperture forming a seal with the outer additive chamber surface and in communication with the aperture. In this embodiment, the opening of the additive chamber allows the additive to be released into the vessel through the aperture. The opening of the additive chamber places the inner surface of the additive chamber into communication with the aperture, which maintains the seal over the aperture. In still another embodiment, the additive chamber is in contact with both the inner and the outer vessel surfaces. In this embodiment, the seal on the additive chamber is oriented toward the inner vessel surface such that the opening of the additive chamber places the additive in communication with the main chamber.

The additive chamber may be composed of one or more materials. The materials should be compatible and non-reactive with the additive that they hold. The materials must be of sufficient strength to withstand the rigors of shipping and handling of the container without opening, yet be openable at the user's option without the need for excessive force. Examples of materials that can be used to manufacture the additive chamber are plastics, including non-stretch plastics, such as Mylar®, rubberized materials, such as latex, flexible foil laminates, high barrier laminated films; cardboard or other paperboard including waxed version thereof, natural fiber and combinations thereof.

In one preferred embodiment, the additive chamber is a blister pack or a gas filled polyethylene chamber similar in construction to an individual bubble in air bubble plastic wrap.

In another preferred embodiment the additive chamber is made of a material that is completely collapsible when the chamber is opened. Collapsing the chamber walls ensures that of the contents of the chamber are released into the base liquid. The material of the additive chamber may be made more susceptible to rupture by including weakening lines, or scoring at the desired site of opening. Such lines or scores may be a single slit, two slits perpendicular to one another (e.g. a cross-shape), or multiple slits in a star-like or asterisk-like conformation. Alternatively, the additive chamber may include a valve, rupturable membrane, hinged door, clamp or other frangible sealing device which may be used to keep the additive in the chamber separated from the liquid in the main vessel chamber until the user desires release of the additive.

The characteristics of the additive chamber and the opening through which the additive leaves the additive chamber can be modified to alter the way the additive is released. For example, the direction in which the additive is released can be oriented through the use of a nozzle within the additive chamber and in communication with the opening produced to release the additive. Alternatively, the orientation of the opening will affect the direction in which the additive is released. Preferably the release of the additive is oriented towards the bottom of the vessel.

The location of the opening can also be altered by selective placing score lines, or other weak points or frangible seals at only a portion of the surface of the additive chamber that is in contact with base liquid chamber. In one preferred embodiment, the opening of the additive chamber occurs at or near the bottom of the chamber, preferably in the lower third, more preferably in the lower quarter of the chamber height. This allows the contents of the chamber to fully empty into the base liquid through the force of gravity as well as any manual pressure placed on the chamber.

The size of the opening can also be altered and will affect the way in which the additive is released. The smaller the opening the greater force the additive be under upon release. Very small openings, such as the size of a pinhole, will cause liquid additives to stream out of the additive chamber providing superior mixing with the base liquid and will also be aesthetically pleasing. Examples of opening sizes through which additive may stream into the base liquid include, but are not limited to 1 mm, 0.75 mm, 0.5 mm, 0.25 mm, or 0.1 mm. Alternatively, the opening may be a closed slit, which acts as a valve, only allowing the additive to travel through it when the additive chamber is placed under manual pressure.

In another embodiment, the additive chamber is a dispenser that holds multiple discrete doses of a solid additive and releases said additive one dose at a time. Examples of such dispensers are, for example, a device like a Pez® dispenser, a Lifesaver® dispenser or a Tic-Tac® dispenser.

The choice of additives in the container of the present invention will be dependent upon the liquid in the main chamber of the vessel. For an edible beverage, each of the plurality of additive chambers comprises an additives independently selected from a colorant, a flavoring, a sweetener, a pharmaceutical, a nutrient, a creamer, tea, coffee, an agent to promote mixing of said liquid and said additive, a carbonating agent or a preservative. More preferably, the plurality of additives comprises at least two, three, four or more different flavorants.

In one embodiment the liquid is carbonated water or a carbonated soft drink, and the plurality of additives is independently selected from a colorant, a flavoring, a sweetener, a pharmaceutical, a nutrient, an agent to promote mixing of said liquid and said additive or a preservative. In a preferred embodiment when the liquid is carbonated water the plurality of additives preferably comprises two, three, four, or more different flavorants. Even more preferred is when the plurality of additives additionally comprises one or two separate additive chambers comprising caffeine.

In a highly preferred embodiment, the liquid is an unsweetened carbonated cola and the plurality of additives chambers comprise separate chambers comprising each of: a cherry flavorant, a lemon flavorant, a lime flavorant, a vanilla flavorant, two separate chambers comprising caffeine, and a separate chamber comprising an artificial sweetener.

When the liquid is a juice, a fruit drink, a sports drink or another non-carbonated soft drink, the plurality of additives is preferably selected from a colorant, a flavoring, a sweetener, a pharmaceutical, a nutrient, an agent to promote mixing of said liquid and said additive, a carbonating agent or a preservative. In a more preferred embodiment, the plurality of additives preferably comprises two, three, four, or more different flavorants.

According to one preferred embodiment, the liquid is selected from water, carbonated water, juice, fruit drink, sports drink or carbonated beverage; and the two, three, four, or more different flavorants are selected from vanilla, lemon, lime, cherry, orange, tangerine, banana, mango, papaya, grapefruit, black cherry, raspberry, strawberry, mixed berry, kiwi, root beer, or apple.

When the liquid is a broth, the additives are independently selected from a colorant, a flavoring, a pharmaceutical, a nutrient, an agent to promote mixing or a preservative. Preferably, the plurality of additives comprises at least two, and preferably three, four, or more flavorants independently selected from salt, black pepper, hot pepper, garlic, onion, an herb or a spice.

When the liquid is coffee, the two, three, four, or more different flavorants are selected from vanilla, apricot, banana, blueberry, butter pecan, bourbon, caramel, cherry, mint, raspberry, coconut, rum, frangelica, macadamia nut, rum, orange, pumpkin, chestnut, maple, white chocolate, pecan, butterscotch, almond, amaretto, hazelnut, mocha, chocolate, or cinnamon.

When the liquid is tea, the two, three, four, or more different flavorants are selected from apple, apricot, blueberry, chocolate, kiwi, strawberry, mint, orange, peach, cherry, tangerine, sassafras, raspberry, passion fruit, mango, lemon, lime, clove, black currant, cinnamon, cranberry, or papaya.

The sources of all of the aforementioned flavorants may be natural or artificial. All of these flavorants are commercially available in concentrated form.

Examples of colorants that may be present in the additive chambers of the container include any color. For edible liquids the presence of colorant additives is most desirable for clear liquids, such as water, carbonated water and uncolored sports and soft drinks, and white liquids, such as milk or other liquid dairy products. However, a colorant additive may also be used with a colored liquid as long as the color of the liquid without the colorant additive is perceptively different from the color of the liquid combined with the colorant.

Preferably, at least a portion of the container will be transparent so that the user can see the colorant mixed with the liquid. In a preferred embodiment, the plurality of additives comprises two, three, four or more different colorants. In one such embodiment, the colorant additives comprise a blue colorant, a red colorant and a green colorant. In a more preferred embodiment, the colorant additives additionally comprise an orange colorant, a yellow colorant, and a violet colorant. In still another embodiment the colorant additives comprise a cyan colorant, a yellow colorant and a magenta colorant and the liquid is a white or clear liquid. In another embodiment, the plurality of additives comprises two, three, four or more fluorescent colorants (e.g., day-glo colorants). It will be readily apparent that with respect to edible beverages the colorant should be non-toxic.

Colorants may also be used together with a flavorant or any other additive in a single additive chamber. The color may be used to designate the flavorant typically associated with that color. For example, a cherry flavorant would include a red colorant, an orange flavorant would include an orange colorant, a lemon flavorant would include a lemon colorant, and so on. A colorant can also be used in conjunction with an additive to aid the user in visualizing the mixing of the additive and the liquid. Different additives present in such containers can be combined with different colorants to distinguish one additive from another both before and after opening of the additive chamber. In such embodiments, the colorant associated with the additive must be sufficiently distinct from the color of the liquid with which it will mix such that the color of the liquid before mixing with the additive differs from the color after such mixing.

Certain additives are associated with colors in the mind or perception of the user. When a colorant is used together with such additives in the same additive chamber, it is preferable that the typical color be selected. For example, a yellow colorant with a lemon flavorant, a green colorant with a mint flavorant or a lime flavorant, a red color with a strawberry or cherry flavorant, etc.

Examples of sweeteners that may be used as additives in the container of this invention include both natural and artificial sweeteners. More specifically, the sweetener may be selected from sucrose, beet sugar, fructose, corn syrup, high fructose corn syrup, honey, saccharine, cyclamate, aspartame, alitame, neotame, acesulfame-K, sucralose or Stevia.

Example of nutrients that may be used as additives in the container of this invention include, but are not limited to, a vitamin, a mineral, an herbal extract, a dietary supplement, an amino acid, a protein, or an enzyme.

Examples of pharmaceuticals that may be used as additives in the container of this invention include, but are not limited to, caffeine, theophylline, a sleeping aid, an analgesic, an anti-inflammatory, a decongestant, a digestive, an antihistamine, an expectorant, a cough suppressant or an erectile dysfunction drug. Preferably, the pharmaceutical is caffeine. For edible beverages, it is preferred that the liquid be non-caffeinated and that the plurality of additives comprises one and more, preferably two, separated additive chambers comprising caffeine.

Examples of preservatives that may be used as additives in the container of this invention include, but are not limited to, EDTA, BHT or benzoic acid.

Examples of an agent to promote mixing that may be utilized as an additive in the container of this invention include, but are not limited to, a gas stored under higher pressure in the additive compartment than the pressure of the main vessel chamber, or an effervescing solid (e.g., a solid comprising a bicarbonate and an acid; or simply comprising a bicarbonate if the liquid itself is acidic). When an agent to promote mixing is present in a container of this invention and that agent is a gas stored under pressure, it is preferred that the additive chamber comprising this additive be opened near a base of the main chamber. This will allow the gas to rise through a greater volume of the liquid, thereby maximizing turbulence and mixing.

Examples of a carbonating agent are CO₂ gas or another source of CO₂ such as carbonates, bicarbonates or another additive made under a CO₂ atmosphere. Like an agent to promote mixing, the carbonating additive should be released at the bottom of the vessel in order to promote carbonation. It should be understood that many carbonating agents will also act an agent to promote mixing. However, a single agent that both carbonates and acts as an agent to promote mixing is considered to be a single additive according to this invention.

Carbonating agents are useful with both carbonated and non-carbonated beverages providing optional carbonation with the latter or increased carbonation with the former. This is particularly useful with a multiple use carbonated beverage container, such as a quart, liter, 2-liter, or half gallon soda container where the liquid tends to lose its carbonation after initial opening and storage for several days. The ability to regenerate carbonation into such a beverage is highly desirable for consumers.

When the liquid is a non-edible liquid, the choice of additives included in the plurality of additive chambers will vary. In one embodiment, the liquid is paint and the plurality of additive chambers comprises a plurality of different tinting agents, pigments or colorants. In one preferred embodiment, the paint is white or light-colored. In a preferred embodiment, the container is packaged with or further comprises a color chart of colors that can be created by opening different colorant additives chambers and instructions for producing those colors. The plurality of additive chambers may comprise the same colorant in multiple chambers, as well as different colorants in different chambers.

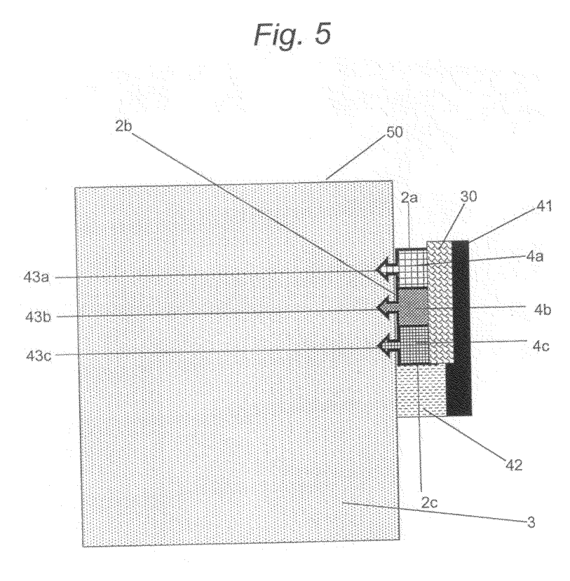

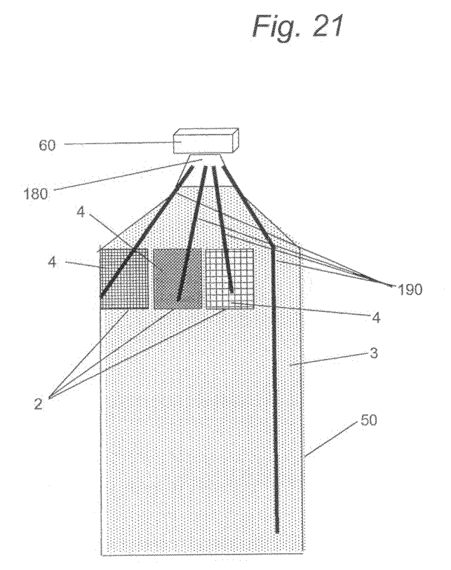

Even more preferred is a white paint base with individual additive chambers comprising cyan, yellow, magenta and optionally black pigments or dyes; or individual additive chambers comprising different pigments used in standard house paints. Release of these additives is preferably controlled by an electronic injector type system (see FIG. 5), which is preferably located in the cover of the container. These paint containers of the invention preferably include a mixing chamber in communication with the main container and with the container outlet (see FIG. 21). In an even more preferred embodiment the container is an aerosol spray can.

In another embodiment, the liquid is a liquid intended for intravenous administration to a subject and the plurality of additive chambers comprises additives selected from a pharmaceutical, a nutrient, a salt or a sugar. In this embodiment, the administration of a pharmaceutical or nutrient to a subject receiving intravenous fluids is achieved without the difficulty or risk associated with injecting such an additive into the existing intravenous line. There is also less chance that sterility of the line of the additive will be compromised since the sealed additive chamber opens directly into the sterile liquid in the container.

In still another embodiment, the liquid is a media for cell growth and the plurality of additive chambers comprises additives selected from a source of amino acids, an antibacterial, an antifungal, an enzyme, a protein, a nucleic acid, a pharmaceutical, a pH-adjusting additive, a salt, a sugar, a color pH indicator, a growth factor, a buffer, a hormone, a steroid, a metal, a nutrient, an antibody, a radioactive tracer, or another cell media additive. This embodiment provides a convenient way to prepare cell culture media without risk of contamination. Very often, components to be added to liquid cell culture media must be kept separate until just before use to prevent breakdown or loss of potency. These components must be added to the liquid media under sterile conditions, which require skill and cost to maintain. The container of this invention allows for the provision of these components in separately sealed additive chambers that can be released into the liquid media at the user's choice without ever exposing the sterile liquid to the air. This reduces wasted time and resources caused by contaminated media. Furthermore, the media-containing containers of the invention allow the user a choice of additives to mix with the media. Thus a manufacturer can offer a wide array of differently supplemented media in the same container.

In an alternate embodiment, the liquid is a perfume or cologne base and said plurality of additive chambers comprises additives selected from a colorant, an essence, or a flavorant. Preferably the plurality of additive chambers comprises two, three, four or more essences each in an independent additive chamber. This embodiment allows the user to choose from a single container the essence he or she wishes to wear. In one embodiment, the two, three, four, or more essences comprise at least one feminine essence and one masculine essence. A feminine essence is an essence known in the perfume and cologne art to be used in odorants marketed for females. A masculine essence is an essence known in the perfume and cologne art to be used in odorants marketed for males. This preferred embodiment may be marketed for use by either or both sexes.

In another embodiment, the liquid is a make-up or a lip gloss, and the additives are preferably selected from a colorant, a nutrient or an ultra-violet light blocking agent. In a more preferred embodiment the plurality of additive chambers comprises two, three, four, or more different colorants, each in a separate chamber. If the liquid is a nail polish or an eye liner, the plurality of additive chamber preferably comprises two, three, four, or more different colorants each in a separate chamber. When the liquid is a deodorant, the plurality of additive chamber preferably comprises two, three, four, or more different essences each in a separate chamber. When the liquid is a hair coloring base, the plurality of additive chamber preferably comprises two, three, four, or more different colorants each in a separate chamber. When the liquid is an artificial suntan cream the plurality of additive chamber preferably comprises two, three, four, or more different colorants each in a separate chamber. It will be readily apparent that the choice of colorant additives in the container will vary depending upon the nature of the cosmetic liquid and must be compatible with such cosmetic liquid in terms of miscibility or solubility, tintability, shade of color, intensity of color, and the like.

It is known that when the liquid is one in which coloration is the main use (e.g., paint, hair coloring, lip gloss, make-up, eye liner, nail polish, etc.) (herein “a coloring liquid”) the addition of differing amounts of the same colorant alone or in combination with one or more other colorants, can produce different colors. Thus, according to a preferred embodiment when the liquid is a coloring liquid, the plurality of additive chambers comprises a means for releasing varying amounts of a colorant into said liquid. Such means include multiple chambers containing the same colorant, wherein the amount of a given colorant released depends upon the number of chambers opened by the user. Those variable release means also include an additive chamber comprising the colorant wherein varying amounts of colorant can be released from said chamber. The release of varying amounts of colorant from a single additive chamber may be achieved through the use of a syringe-like mechanism, a squirt gun-like mechanism, a pump-like mechanism, a pipette-like mechanism, an electric release mechanism such as a piezoelectric release mechanism or a thermal ink-jet head-like mechanism, or, in the case of solid block colorant, a grinder-like mechanism which creates particulate pieces from said block (i.e., a pepper mill). It is also within the scope of this invention for the additive chamber to be a reservoir connected to the vessel through a hose-like connector.

The ability to release varying amounts of a colorant will allow the user to fine-tune the final color of the liquid and to adjust the final color by adding additional colorant after sampling the result of an initial mix.

The use of means for releasing varying amounts of a colorant or of other additives is particularly useful for multiple use containers of this invention. A multiple use container is a container that comprises a sufficient volume of liquid and sufficient additives for more than a single use. Alternatively, a multiple use container is a refillable container that comprises sufficient additives for more that a single use. All of the liquids disclosed herein are adaptable to multiple use containers. It is preferred that a multiple use container be constructed to allow the user to potentially choose the same or different additives or combinations of additives for each use. This requires a reservoir of liquid from which a single use volume can be removed prior to mixing with the selected additives or a refillable main chamber.

In a preferred embodiment, a multiple use container of this invention is achieved by having the vessel additionally comprise a mixing chamber in communication with the outlet, the additive chambers and the main chamber. The additives are opened into the mixing chamber. Liquid in the main container can enter the mixing chamber, but nothing in the mixing chamber can flow back into the main chamber. This one-way directional flow can be achieved by a one-way valve, a one-way diaphragm or the like. Preferably, the volume of the mixing chamber is equal to the volume required for a single use. In this manner, the additives selected by the user are mixed with a single use volume of liquid and do not contaminate the reservoir of liquid. This allows the user of the container to vary the additives and thus the resulting mixed liquid upon every use.

According to an alternate embodiment, the liquid is a cleaning agent base and the plurality of additive chambers comprises additives independently selected from a bleaching agent, an essence, a concentrated cleaning agent, a grease-cutting agent, ammonia, or a disinfectant.

In a related embodiment, the liquid is a disinfecting agent base and the plurality of additive chambers comprises additives independently selected from a bleaching agent, an essence, a cleaning agent, a grease-cutting agent, ammonia, or a concentrated disinfecting agent.

In yet another embodiment, the liquid is an air freshener (aerosol deodorant) base and the plurality of additive chambers comprises additives independently selected from an essence or a concentrated disinfecting agent. More preferably, the plurality of additive chambers comprises two, three, four, or more different essences in separate additive chambers.

In another embodiment, the liquid is an agricultural base liquid, such as a pesticide base, a fertilizer base, or a plant food base. When the liquid is a pesticide based, the plurality of additive chambers comprises additives that are pest-specific toxins. Preferably a container that is filled with a pesticide base liquid additionally comprises two, three, four, or more different pest-specific toxins each in an individual additive chamber. A “pest-specific toxin” is a toxin known to be selective for certain species, genera, families or other category of agricultural pest.

If the liquid is a fertilizer or plant food base, the plurality of additive chambers comprises additives selected from plant hormones, plant nutrients, and pesticides. More preferably, the hormones, nutrients and pesticide additives may be plant-specific (e.g., targeted to certain species, genus, family, etc. of plant), season-specific (e.g., targeted for Spring, Summer, Winter, Fall, growing season, etc.), health-specific or pest-specific.

In another embodiment, the liquid is a clothing dye base and the plurality of additive chambers comprises two, three, four, or more different colorants in separate additive chambers.

Each of the above containers comprising a liquid selected from a cleaning agent base, a disinfecting agent base, an air freshener base, a pesticide base, a fertilizer base, a plant food base or a clothing dye base is particularly well-suited for a multiple use container.

In another alternate embodiment, the liquid is an emollient and the plurality of additive chambers comprises additives independently selected from an essence, a coloring agent, an ultra-violet light blocking agent, a nutrient, or an insect repellant. When the emollient is a suntan lotion base, it is preferred that the container comprises two, three, four, or more additive chambers containing the same or different ultra-violet light blocking agents. This allows the user to choose the strength of protection from the sun. Even more preferred is when the container comprising the suntan lotion base is a multiple use container, thus allowing the user to alter the sun protection factor of the lotion upon each use. Ultra-violet light blocking agents useful as additives in the containers of this invention include, but are not limited to, paraminobenzoic acid (PABA), methoxycinnamate, homosalate, octyl salicylate, oxybenzone. When the emollient is a body lotion, it is preferred that the plurality of additive chambers comprises two, three, four, or more different essences in separate additive chambers. It is even more preferred that said container be a multiple use container

For any chosen liquid, the additives present in the plurality of additive chambers should be selected so that the user of the container is presented with a choice for producing liquids that differ from one another. In this manner a manufacturer can offer different versions of the same base liquid from a single container.

The list below sets forth some of the preferred additives that may be used in this invention.

PHARMACEUTICAL ADDITIVES

Sleep Aids

Pain Reliever

Ibuprofen

Aspirin

Acetaminophen

Naproxen

COX-2 inhibitors

Decongestants

Digestion Aids

Antihistamines

Expectorants

Cough Suppressants

Erectile Dysfunction Drugs

DERMAL (COSMETIC) ADDITIVES

Pigments

Dyes

Fragrances

Moisturizers

UV blocking agents (e.g. PABA)

Disappearing dyes for tracking (e.g. for sun block)

Lanolin

Fragrances

Protestants

Moisturizers

Repellants (e.g. DEET)

PAINT ADDITIVES

Pigments

glitter

dyes

texturizing materials (e.g. sand)

insoluble colored flakes

PERFUME ADDITIVES

Fragrances

Pheromones

FUEL (GASOLINE) ADDITIVES

oil

octane substitutes

ENGINE OIL ADDITIVES (e.g. SAE grade modifiers)

VITAMIN ADDITIVES

Vitamin A

Vitamin C

Vitamin E

Vitamin D

B vitamins

Riboflavin

MINERALS (NUTRIENT) ADDITIVES

Iron

Selenium

Calcium

Zinc

Potassium

Magnesium

Manganese

FLAVORANT ADDITIVES

Lemon

Vanilla

Coffee

Chocolate

Strawberry

Lime

Cherry

Grape

Bubblegum

Cranberry

Raspberry

Mint

Peppermint

Capsaicin

Mint

Cinnamon

Spearmint

Sour flavor

unami flavor

COLORANT ADDITIVES

Red, yellow, and blue to allow mixing to obtain all colors

Cyan, magenta, and yellow (primary subtractive colors)

Rainbow (red, yellow, blue, green, orange, purple)

HAIR TREATMENTS/CLEANER ADDITIVES (SHAMPOO, HAIR COLOR, CONDITIONER)

Pigments

Moisturizers

Curl promoters

Conditioner

Anti-dandruff compound

Zinc

Coal Tar

HERBS AND SPICES ADDITIVES

Salt

Black Pepper

Hot Pepper (Capsaicin)

Synthetic Hot Pepper (Capsaicin)

MISCELLANEOUS EDIBLE ADDITIVES

Cream

Milk

Caffeine

Alcohol

Orange pulp

CANDY ADDITIVES

Chocolate chips

coconut flakes

Oreo cookies

Candies

M and M Chocolate

Candy sprinkles

CLEANER ADDITIVES

Grease cutter

Stain Remover

Alternate cleaner

CELL GROWTH MEDIA ADDITIVES

Magnesium

Glutamine

Antibiotic

Salts

ATP

Indicator dyes (e.g. phenol red)

Acids

Bases

Buffers

Enzymes

Proteases

Antibodies

Fluor or Probe

Radioactive tracers

αFGF.

βFGF

EGF

GDNF

NGF

PDGF

Fibronectin

Laminin

BUFFERS

HEPES buffer

Sodium Bicarbonate

Cholesterol

Albumin

B-27 Serum-Free Supplements

BSA Fraction V

Pituitary Extract

G-5 Supplement

Insulin

Transferrin

Transferrin plus insulin

lactalbumin hydrolysate

N2 Supplement

GlutaMax brand supplement

L-Glutamine

MEM Amino acids concentrated solution

MEM Non-Essential Amino Acids Solution concentrated solution

Alpha-Thioglycerol

nucleotide supplements

Mineral supplement

zinc

iron

Phenol Red

OptiMAB monoclonal supplement

hypoxanthine and thymidine

sodium hypoxanthine, aminopterin and thymidine

sodium pyruvate

D-Glucose

Vitamins

beta-mercaptoethanol

Calcium Chloride

magnesium sulfate

Detachment factors (for cell culturing containers)

INSECT CELL MEDIA ADDITIVES

BACTERIAL GROWTH MEDIA ADDITIVES

OTHER DIETARY SUPPLEMENTS

Omega 3 fatty acids

Alpha lipoic acid

Astaxanthin

beta glucans

Bilberry extract

Grape seed

L-Glutathione

Lycopenes

Soy Isoflavones

5-HTP

Citicoline

Phosphatidyl Serince

Vinpocetine

Chondroitin Sulphate

Collagen

Glucosamine

SAMe

Co Enzyme Z 10

Fish Oil

Red clover extract

Conjugated Linoleoic Acid

Glucomannan

Guarana PE

Theobromine

Wheat Amylase

White kidney bean extract

Black Cohosh

Cranberry powder

Horsetail extract

Soy isoflavones

The list set forth below provides some preferred combinations of a specific additive with a specific base liquid. It should be understood that additional additives may also be present in these base liquids. It should also be understood that the listed additive may be present in a single additive chamber or in separate multiple additive chambers and that when present in separate multiple additive chambers, the amount of additive in each of those multiple chambers can be the same or different.

Pharmaceutical Additives

medicine base liquid

herbal remedy or herbal supplement base liquid

baby formula

dermal cosmetic base

vitamin and mineral supplement base liquid

drinking waters

hair care product base liquid

flavored drinking bases

liquid foods

liquid air freshener bases

cell growth media

biochemical research reagent base liquid

diagnostic reagent base liquid

intravenous infusion base liquid

Dermal (Cosmetic) Additives

medicine base liquid

herbal remedy or herbal supplement base liquid

dermal cosmetic base

perfume base solvent

hair care product base liquid

Pigment or Dye Additives

medicine base liquid

herbal remedy or herbal supplement base liquid

dermal cosmetic base

perfume base solvent

paint base

vitamin and mineral supplement base liquid

drinking waters

hair care product base liquid

flavored drinking bases

liquid foods

liquid air freshener bases

underarm deodorant and/or antiperspirant base liquid

cell growth media

biochemical research reagent base liquid

diagnostic reagent base liquid

intravenous infusion base liquid

Fragrance Additives

dermal cosmetic base

perfume base solvent

Moisturizer Additives

herbal remedy or herbal supplement base liquid

dermal cosmetic base

perfume base solvent

hair care product base liquid

Insect Repellant Additives (e.g., DEET)

dermal cosmetic base

perfume base solvent

hair care product base liquid

UV Blocking Agent Additives (e.g., PABA)

dermal cosmetic base

hair care product base liquid

Pheromone Additives

herbal remedy or herbal supplement base liquid

dermal cosmetic base

perfume base solvent

hair care product base liquid

Oil Additives

fuel

Vitamin Additives

medicine base liquid

herbal remedy or herbal supplement base liquid

baby formula

dermal cosmetic base

vitamin and mineral supplement base liquid

drinking waters

hair care product base liquid

flavored drinking bases

liquid foods

liquid air freshener bases

cell growth media

biochemical research reagent base liquid

intravenous infusion base liquid

Supplemental Mineral Additives

medicine base liquid

herbal remedy or herbal supplement base liquid

baby formula

dermal cosmetic base

perfume base solvent

vitamin and mineral supplement base liquid

drinking waters

hair care product base liquid

flavored drinking bases

liquid foods

cell growth media

biochemical research reagent base liquid

diagnostic reagent base liquid

intravenous infusion base liquid

Flavorant Additives

medicine base liquid

baby formula

vitamin and mineral supplement base liquid

drinking waters

flavored drinking bases

liquid foods

Herb and Spice Additives

herbal remedy or herbal supplement base liquid

dermal cosmetic base

vitamin and mineral supplement base liquid

drinking waters

hair care product base liquid

flavored drinking bases

liquid foods

liquid air freshener bases

underarm deodorant and/or antiperspirant base liquid

Cleaning Agent Additives

dermal cosmetic base

hair care product base liquid

cleaning agent base liquid

Other Dietary Supplement Additives

medicine base liquid

herbal remedy or herbal supplement base liquid

baby formula

dermal cosmetic base

vitamin and mineral supplement base liquid

drinking waters

hair care product base liquid

flavored drinking bases

liquid foods

cell growth media

intravenous infusion base liquid

The additives used in the containers of this invention may be in liquid, suspension, emulsion, solid, aerosol or gaseous form. The liquid additives may be aqueous or organic, as long as it is compatible with the liquid in the vessel. The term “compatible” as used herein with respect to the form of additive and the vessel liquid typically means acceptably combined for the intended use. Acceptable combinations of additive and liquid may mean that the additive is soluble, miscible, emulsifiable or temporarily mixable (e.g., as in the case of the liquid being an edible oil and the additive being a vinegar to produce a dressing) in the liquid. A solid additive may be a continuous block solid, such as a stick, tablet, a disc, a bar or a sheet, crystalline, particulate, flakes, a powder, microspheres, nanospheres, a roll of individual discs (e.g., such as Lifesavers®), a stack of individual blocks (e.g., such as Pez®), a collection of individual tablets (e.g., such as Tic-Tacs®), or a combination of any of the above. In another preferred embodiment, the additive is a particulate solid where said particles are size distributed for even distribution when placed in communication with the liquid. In yet another preferred embodiment the additive is a liquid miscible with the liquid in the vessel. Preferably, the solid is soluble in the liquid. However, solid additives that are extractable by the liquid, such as tea or coffee, are also within the scope of this invention. When non-soluble solids are utilized as additives in the containers of this invention, it is preferred that they be stored in a liquid permeable, solid impermeable holder within the additive chamber. One example of such a holder is a tea bag.

It is also preferred that when a container comprises a solid additive that is soluble in the liquid, the container further comprises an additive which facilitates mixing so as to accelerate the dissolution of the solid additive in the liquid. In a preferred embodiment, a chamber that comprises a solid additive and a chamber that comprises an additive that facilitates mixing are utilized with a base liquid selected from a medicine base liquid, an herbal remedy or herbal supplement base liquid, a paint base liquid, a vitamin and mineral supplement base liquid, a drinking water, a flavored drinking base, a biochemical research reagent base liquid, a diagnostic reagent base liquids or an intravenous infusion base liquid.

In another embodiment, a liquid additive may be stored in a frangible holder, such as a bead, gelatin capsule, paintball-like holder, etc., within an additive chamber. In this embodiment the inner surface of the additive chamber must comprise a portion that causes the frangible holder to break and release the additive when the user applies sufficient manual pressure to the outer wall of the additive chamber. Such a portion may be simply a rigid region which the user forces the frangible holder against with sufficient pressure to cause bursting. Alternatively, such a portion may comprise rough, jagged or pointed elements that cause breaking of the frangible holder when the holder comes into contact with that inner wall portion. The frangible holder may be made more susceptible to rupture by including weakening lines, or scoring on a portion of its surface. Such lines or scores may be a single slit, two slits perpendicular to one another (e.g. a cross-shape), or multiple slits in a star-like or asterisk-like conformation. One advantage to the use of a frangible holder within an additive chamber is ease of loading the additive into the chamber during the manufacturing process.

It will be apparent to those of skill in the art that the storage of additives in sealed chambers advantageously increases the shelf-life of both the additive and the desired mix of additive and base liquid. Many additives break down over time when mixed with the base liquid. Thus, the containers of this invention also provide increased stability for the mixture of additive and liquid. Additive chambers may additionally comprise an inert gas to prevent break down of certain additives when exposed to oxygen. Examples of inert gases that may be used are nitrogen and argon.

The volume, concentration and form of additive in each of the plurality of additive chambers may be the same or different. The volume of additive in any single additive chamber may range from 0.01% to 10% (volume/volume or weight/volume) of the volume of the main vessel chamber. More preferably, the amount will range from between 0.1% and 2% of the main vessel chamber volume. When the additive is in liquid form, it will preferably be concentrated with respect to the concentration of that additive typically associated with the liquid. For each additive chamber, the concentration of a liquid additive will preferably be based on the volume of the additive and a single use volume of the liquid, more preferably between 10 and 10,000 times the concentration of additive typically associated with the liquid and most preferably between 50 and 1,000 times the typical concentration of the additive in the liquid. In some embodiments, the minimum volume of liquid additive in a single additive chamber may be limited by the ability to produce such additive in sufficient concentration.

The additive chambers present in the container of the invention must be openable by the user. Moreover, the opening of the chamber does not violate the integrity of the vessel. In one embodiment, the additive chamber comprises an integrated device to opening the chamber. Such a device includes, but is not limited to, a plunger, a syringe, a pump, a nebulizer or other aerosol release device, a valve, a diaphragm, an electronic injector or jet such as a piezoelectric injector or a thermal inkjet head-like device, a piercing device, a bursting device, a shutter, a door, a squirter, or a cylinder and piston device. One specific example of a valve is a miniature soda fountain-type dispenser that employs a valve block connected to and controlling release of additive from multiple additive chambers. One preferred example of a piercing device is a barb with a hollow center. When the barb is forced through the additive chamber wall, a liquid additive can flow out of and the liquid in the vessel can flow into the chamber. Another example of a piercing device may be the additive itself when the additive is in the form of a large crystal with a pointed end. When the additive chamber is manually deformable, the user applies pressure to the additive chamber forcing the crystal to pierce the chamber wall and come into communication with the liquid.

In certain other embodiments, the opened chamber will remain deformed to indicate that the additive contents have been emptied. This may be achieved by locking the integrated opening device in the open position. For example, the opening device may be a barbed piercing device that locks in the open position when inserted through the vessel wall (or a hole in the vessel wall) past the barbs.

In an alternate embodiment, applying pressure to the outer surface of the additive chamber opens the chamber. The application of such force causes the chamber to burst or otherwise open ejecting the additive contents into the vessel. The force may be supplied directly by the user's finger or through the action of a lever-type device that when maneuvered by the user pierces or bursts the chamber or otherwise causes the chamber to open.

One preferred embodiment of lever-type device is a series of “keys” or other depressible “buttons” on the outside surface of the vessel. Each key is a lever that, when depressed, opens an additive chamber located within the vessel. The keys are preferably coded or otherwise labeled in a manner that the user can select the desired additive to be released by depressing the appropriate key.

In one preferred embodiment of a non-lever type device, the chamber is a gas filled plastic bubble, which bursts and expels its content upon the exertion of pressure on the outer surface by the user. In an alternate preferred embodiment the chamber is a blister pack. In another alternate preferred embodiment the chamber is a rigid, breakable additive chamber within the main chamber, or a heat-sealed or glued chamber present as a division of the main chamber.

In preferred embodiments, the additive chambers are formed into buttons projecting from the outer surface of the vessel. The buttons may be labeled, colored, or otherwise enhanced to indicate the presence of a particular additive. Depressing the button activates the mechanism required to open the additive chamber. In one embodiment, the buttons further comprise accordion fold sides, baffles or another mechanism that keeps a depressed button in the depressed state to indicate that the additive chamber has been opened. In one of the most preferred embodiments, the additive chamber is a raised, hollow, flexible button sealed to the outer surface of the vessel and surrounding an aperture in the vessel, wherein a plug or an impermeable sheet seals the aperture. In this embodiment, the plug or impermeable sheet serves as a common wall of the vessel and the additive chamber and may be considered part of the additive chamber in order to produce a seal when closed. When the button is depressed the plug is opened or the impermeable sheet is torn open forcing the content of the additive chamber into the vessel.

In a further preferred embodiment, the additive is a liquid additive and the aperture is small enough such that depressing the button forces the contents of the additive chamber to be released as a stream, preferably a stream of sufficient length to contact the opposite side of the vessel. This can be achieved with an aperture that has the diameter approximating a pinhole. The advantage of such a small aperture are better mixing of the additive and the base liquid during additive release; and superior aesthetic value.

The list set forth below provides some preferred examples of the mechanisms by which an additive chamber may be opened in the containers of this invention.

Button

Button formed by a separation between the inner and outer container surface

Button with accordion pleated edges

Button where Surface of container is button surface

Button where the Inner surface is concave

Button located on Surface that communicates through hole in container wall

Lever activated

Pull Tab Trap Door

Injector

Push activated

Piezoelectric jet

Thermal jet

Syringe type

Mixing chamber in communication with main container liquid exit

Stop-cock controlling flow

Screw type valve controlling flow

Ball valve controlling flow

As above, with additive reservoir inside container

As above, with additive reservoir integrated in container wall

As above, with additive reservoir outside of container

Rigid Breakable additive reservoir within main container

Heat-sealed or glued divisions in a bag.

Solid Dispensers

Pez®-Type Dispenser

Roll (like Lifesavers®)

Container with reclosable cover (like Tic Tac®)

Salt Shaker type dispenser

Pump

Spray pump

Toothpaste-type pump

Squirt gun

Bulb type pump

Hemispherical bulb (like Nike Air®)

Pipetter

Pen injector (like the Insulin Pen)

Positive Displacement Type

Blister-Pack Type

Additive impregnated filter

Miniature soda fountain-type dispenser with valve block (similar to that used in DNA synthesizers)

Internal (inside container) burstable packet

Valveless Piston Design (Fluid Metering, Inc.)

Liquid Proportioning Type Dispenser (DSA, Inc.)

The list set forth below provides some preferred examples of specific additive chamber release mechanisms associated with specific base liquids.

Button

medicine base liquid

herbal remedy or herbal supplement base liquid

baby formula

dermal cosmetic base

perfume base solvent

paint base

fuel

vitamin and mineral supplement base liquid

drinking waters

hair care product base liquid

flavored drinking bases

liquid foods

liquid air freshener bases

underarm deodorant and/or antiperspirant base liquid

cell growth media

biochemical research reagent base liquid

diagnostic reagent base liquid

intravenous infusion base liquid

Injector

medicine base liquid

herbal remedy or herbal supplement base liquid

dermal cosmetic base

perfume base solvent

paint base

vitamin and mineral supplement base liquid

drinking waters

flavored drinking bases

liquid foods

liquid air freshener bases

cell growth media

biochemical research reagent base liquid

diagnostic reagent base liquid

intravenous infusion base liquid

Mixing chamber in communication with main container liquid exit

dermal cosmetic base

perfume base solvent

paint base

drinking waters

hair care product base liquid

flavored drinking bases

liquid air freshener bases

underarm deodorant and/or antiperspirant base liquid

intravenous infusion base liquid

Rigid Breakable additive reservoir within main container

medicine base liquid

herbal remedy or herbal supplement base liquid

baby formula

dermal cosmetic base

perfume base solvent

paint base

fuel

vitamin and mineral supplement base liquid

drinking waters

hair care product base liquid flavored drinking bases

liquid foods

liquid air freshener bases

underarm deodorant and/or antiperspirant base liquid

biochemical research reagent base liquid

diagnostic reagent base liquid

intravenous infusion base liquid

Heat-sealed or glued divisions in a bag.

medicine base liquid

herbal remedy or herbal supplement base liquid

dermal cosmetic base

perfume base solvent

vitamin and mineral supplement base liquid

drinking waters

hair care product base liquid

flavored drinking bases

biochemical research reagent base liquid

diagnostic reagent base liquid

intravenous infusion base liquid

Pump

medicine base liquid

herbal remedy or herbal supplement base liquid

baby formula

dermal cosmetic base

perfume base solvent

paint base

fuel

vitamin and mineral supplement base liquid

drinking waters

hair care product base liquid

flavored drinking bases

liquid air freshener bases

underarm deodorant and/or antiperspirant base liquid

cell growth media

biochemical research-reagent base liquid

diagnostic reagent base liquid

intravenous infusion base liquid

Blister-Pack Type

medicine base liquid

herbal remedy or herbal supplement base liquid

baby formula

dermal cosmetic base

perfume base solvent

paint base

vitamin and mineral supplement base liquid

drinking waters

hair care product base liquid

flavored drinking bases

liquid foods

liquid air freshener bases

underarm deodorant and/or antiperspirant base liquid

cell growth media

biochemical research reagent base liquid

diagnostic reagent base liquid

intravenous infusion base liquid

Additive impregnated filter

drinking waters

flavored drinking bases

liquid air freshener bases

Miniature soda fountain-type dispenser with valve block (similar to that used in DNA synthesizers)

medicine base liquid

drinking waters

flavored drinking bases

Internal (inside container) burstable packet

medicine base liquid

herbal remedy or herbal supplement base liquid

baby formula

dermal cosmetic base

perfume base solvent

paint base

fuel

vitamin and mineral supplement base liquid

drinking waters

hair care product base liquid

flavored drinking bases

liquid air freshener bases

biochemical research reagent base liquid

diagnostic reagent base liquid

intravenous infusion base liquid

The location of the additive chambers may be anywhere on the vessel including the sides, the bottom, the punt (recess in the bottom of many bottles and cans), or the top. They may also be in a cap sealing the container with the proviso that if a container is fillable with an edible liquid comprises additive chambers located only in the cap and further comprises an additive in an additive chamber that is a colorant, then said container must also comprise an additive in an additive chamber that is not a colorant. In a preferred embodiment, the additive chambers are arrayed radially around a portion of the container, wherein the container is a bottle. In an even more preferred embodiment, the radially arrayed additive chambers are located between the outlet of the bottle and the portion of the bottle having the largest circumference. Most preferred is that the additive chambers are located at or near the neck of the bottle. Such location allows the user to avoid unintended contact with the additive chamber when gripping the bottle at the portion of its widest circumference. This location of the additive chambers will also be ergonomically efficient. The user can grip the bottle at its widest circumference while simultaneously being able to apply sufficient manual pressure with a thumb to open an additive chamber on the bottle.

In another embodiment the container is a can and the additive chambers are located in a capping piece that attaches to and is rotatable around the top of the can. The capping piece comprises multiple additive chambers each containing the same or different additives. The additive chambers are oriented in the capping piece such that when opened under manual pressure by the user the additive contained therein can be released into the can. The capping piece also comprises an aperture that allows the user access to open the can. Once the can is opened, the user rotates the capping piece so as to align an additive chamber of choice over the can opening. The additive chamber may then be opened by any of the means previously set forth above causing the additive to be released from the chamber and into the vessel chamber to mix with the base liquid. In this embodiment, the capping piece is optionally removable from the can. By being removable, the capping piece may be manufactured and loaded with additives separate from the can and may also be sold separately from the can of base liquid.

The size of the additive chambers can vary, but it is preferred that they be relatively small as compared to the size of the vessel. The shape of the vessels can also vary. Any geometric or free-form shape can be utilized. For chambers that are manually broken by the user, it is preferred that the portion of chamber that extrudes outward from the vessel wall be flat or rounded. If buttons are used as chambers or to cover the surface of chambers, those buttons may be round, square, rectangular, oval, diamond-shaped, hexagonal, octagonal or any other shape. Round or oval buttons are preferred, as they correspond to the impression of a fingertip pressing the button.

In a preferred embodiment, the container comprises multiple chambers each comprising the same additive. Still more preferred is a container comprising multiple chambers when each of the chambers comprises a different amount of the same additive. A different amount of additive may be achieved by increasing the volume of the additive, increasing the concentration of the additive, or both. For example, in one embodiment, a container holding a sauce base or a broth base comprises three additive chambers containing a hot sauce. The chambers are each different in size (small, medium and large). This provides the user with the option of adding a small, medium or large amount of hot sauce to the base liquid, thereby allowing the user to control the spiciness of the resulting sauce or broth.

Most preferred is three chambers comprising 1×, 2× and 4× an amount of the same additive, respectively; four chambers comprising 1×, 2×, 4× and 8× an amount of the same additive, respectively; or five chambers comprising 1×, 2×, 4×, 8× and 16× an amount of the same additive, respectively. This geometrical distribution of additives allows the user to add any amount from 0 to (2n−1)*X of that additive to the liquid, where n is the number of chambers comprising the same additive, by opening one or a combination of these chambers. Thus, five chambers comprising 1×, 2×, 4×, 8× and 16× an amount of the same additive, respectively, allows the user to add 32 different amounts of that additive (0×, 1×, 2×, 3×, 4×, . . . 31×) depending upon the combination of chambers that are opened.

The use of multiple chambers comprising the above geometrically increasing amounts of the same additive allows the user to create a remarkably wide variety of different liquids with a surprisingly small number of additive chambers. For example, a container of the this invention comprising a clear or white liquid base and containing 20 additive chambers: 5 each comprising the individual colorants cyan, magenta, yellow and black; each in 1×, 2×, 4×, 8× and 16× amounts, can produce 32⁵ or over 33 million different colors.

The distribution of the plurality of chambers on the vessel can also vary widely. One preferred distribution is an equidistant spacing around a circumference of a vessel. Another preferred distribution is a grid-like array. Preferred grid arrays are 5×5, 5×4, 4×5, 5×3, 3×5, 4×4, 4×3, 3×4, and 3×3. The grid array is particularly preferred when it is likely that the user will open multiple additive chambers for a single use.

The grid array is also preferred when the same additive is present in a plurality of separate chambers. Even more preferred is when the grid array comprises multiple chambers comprising geometrically increasing amounts of the same additive. In this latter use, the grid is preferably arrayed such that the plurality of chambers containing the same additive is aligned in a single row or column of the grid.

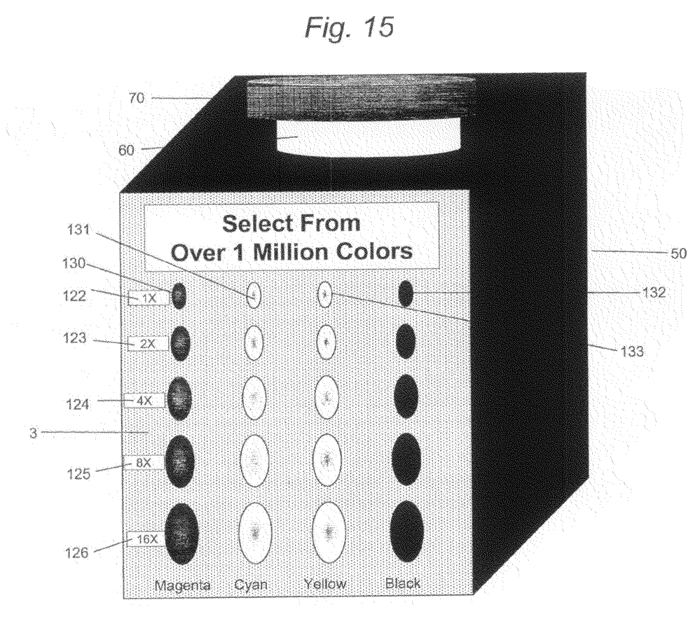

Even more preferred is when every row or column of additive chambers in the grid comprises a geometrically increasing amount of a compatible additive of the same additive class (e.g., all flavorants or all colorants). The term “compatible additive of the same additive class” as used herein means that the additive may be mixed with other additives of the same class and the base liquid to create a usable product. Such an embodiment is shown in FIG. 15.

According to another preferred embodiment the additive chambers are covered with a resealable, tamper-proof, child resistant cover or lid. In an alternate embodiment, the additive chambers are covered with a tamper-proof covering that is removable upon first use of the container.

According to another preferred embodiment, the additive chambers cannot be opened in an originally sealed container of this invention until the original seal is broken. This reduces unintentional or malicious opening of additive chambers on containers of this invention before such opening is desired by the consumer, (e.g., on store shelves, by children “playing” with the buttons that are the additive chambers, as the result of the container dropping on the floor, etc.). This embodiment is preferentially applied to containers comprising edible beverages wherein the additive chambers are manually openable through the application or pressure to the outside chamber wall. Most preferably, the beverage is a carbonated beverage.

The initial resistance of the additive chamber to accidental or malicious opening may be achieved by initially sealing the container under pressure. This is typically accomplished by using a head gas, such as nitrogen or carbon dioxide. Alternatively, and particularly in the case of carbonated beverages, the beverage itself may generate pressure upon initial sealing. The force required to open an additive chamber in such a sealed container is the sum of the pressure required to deform the walls of the additive chamber plus the pressure exerted by the base liquid and any head gas on the walls of the additive chamber. Once the container is opened and the head gas released, the pressure required to open the additive chamber decreases even if the container is then reclosed.

In one embodiment the force required to open the additive chamber prior to head gas release is greater than the force that can be generated by the finger of an average five-year old, preferably greater than the force that can be generated by the finger of an average 8 year old, more preferably greater than the force that can be generated by the finger of an average 10 year old, or even more preferably, greater than the force that can be generated by the finger of an average adult). In another embodiment the force required to open the additive chamber prior to head gas release is at least 1.1, 1.2, 1.3, 1.4 or 1.5 times or greater than the force that can be generated by the finger of an average adult male. The amount of force generated by an average adult male finger is less than about 30N (R. C. Gilbert, “A Program for Quantifying Humanlike Finger Forces Using an Anatomical Hand Tendon Model,” Masters Thesis, Brown University (May 2001); www.cs.brown.edu/publications/theses/masters/2001/rcg.pdf). Although the inventors do not know of any studies on the amount of force generated by a child's finger, it is assumed for the purposes of the present invention that the average force generated by the finger of a five year old is less than about 10N, the average force generated by the finger of an eight year old is less than about 15N, and the average force generated by the finger of a ten year old is less than about 20N. In each of these embodiments, it is preferred that an average five-year old be able to open the additive chamber following head gas release.

Once the user has opened the desired additive chambers, the resulting mixture of additive(s) and base liquid should be mixed before use. Mixing may be achieved simply by shaking or inverting the sealed container before opening. In one embodiment, the main chamber or the mixing chamber may comprise a structure for facilitating the mixture of the additive and the base liquid. Examples of such structures includes, but are not limited to, a propeller affixed to the bottom and/or side of the main chamber, a rigid ball with a diameter larger than the diameter of the outlet, or baffles attached to the side of the main chamber.

The containers of the present invention may be manufactured by standard container-manufacturing techniques well-known in the art. In one embodiment, a container of this invention is made as a multi-piece construction that is heat welded, sonic welded, glued together or the pieces otherwise affixed to one another to form the container ( ). An outer piece made of a flexible material, such as a flexible PET) contains outward protrusions defining areas that will become additive chambers in the assembled container. The outer piece corresponds in shape to at least a portion of the final assembled container. More preferably, the outer piece corresponds in shape to the top portion of the final assembled container. The outer piece is designed to fit snugly over the corresponding portion of the inner piece.

The inner piece is made of slightly less flexible material, such as a more rigid PET. The inner piece corresponds in shape to the final container. The inner piece either lacks protrusions or comprises inward protrusion that will align with the outward protrusions of the outer piece when the container is assembled. The inner piece may also comprise apertures that align with at least a portion of the outer piece protrusions. These apertures allow the formed additive chamber in the assembled container to be filled from the inside of the container. At sites that align with the protrusions present on the outer piece, the inner piece may also comprise an element that is capable of opening when manual pressure is applied to the outer protrusion in the assembled container. Such an element includes, but is not limited to, weakening lines, scoring, a rupturable membrane, a hinged door, or another element that is capable of opening when manual pressure is applied to the outer protrusion in the assembled container.

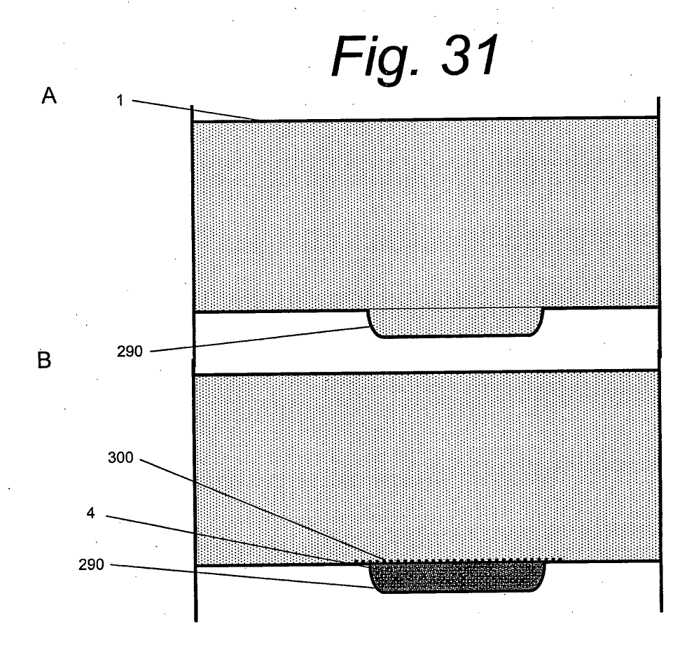

Once assembled together, the inner and outer pieces are fused together, such as by heat welding or by gluing. This process creates a chamber at the site of each outward protrusion on the outer piece that can be filled with a liquid additive. Both the outer and inner pieces comprise openings at their top. The opening at the top may define the container outlet in the final assembled container. FIG. 31 shows an example of this method of manufacture.

Once assembled an additive chamber may be filled from either the inside or the outside of the container. In one preferred embodiment, an additive chamber is filled from the inside of the container through apertures present in the inner piece. In a more preferred embodiment, an additive chamber is filled by injecting a liquid additive through an inner piece aperture into an additive chamber from the inside of the container and then sealing the aperture with a frangible seal concomitant with or immediately following removal of the additive injection device. The frangible seal can then be broken by applying manual pressure to the protrusions on the outside of the container, thus releasing the additive chamber contents into the main chamber of the vessel.

In another preferred embodiment, the inner piece comprises an element that is capable of opening when manual pressure is applied to the outer protrusion in the assembled container. In this embodiment it is preferred that the additive chamber be filled with additive from the outside of the container. This may be achieved by injection of the additive into the chamber with a fine needle followed by a sealing of the aperture created at the injection site. Sealing may be achieved by heat or by the insertion of a sealing device, such as a plug. In this embodiment, the force necessary to break the seal must be stronger than the force necessary to break the opening element present on the inner piece. In an alternate embodiment, the protrusions present on the outer piece may comprise apertures through which additive can be placed in the additive chamber.

In yet another method of manufacture, a container of this invention may be made by providing a vessel comprising outward protrusions in the vessel wall that will be formed into additive chambers. In this embodiment, a film or membrane is affixed to the inner wall of the vessel at the site of the protrusion to form a sealed additive chamber. Each chamber may be filled with additive prior to sealing by placing the container on its side such that the protrusion can be filled by gravity. The filled protrusion is then sealed and the container rotated so that the next protrusion can be filled and sealed. The process is repeated until all of the chambers have been filled with additive and sealed. Alternatively the chambers can be sealed empty and then filled by injection into the additive chamber from the inside of the container or the outside of the container, followed by appropriate sealing, such as described above for other manufacturing methods. FIG. 31 shows an example of this method of manufacture.

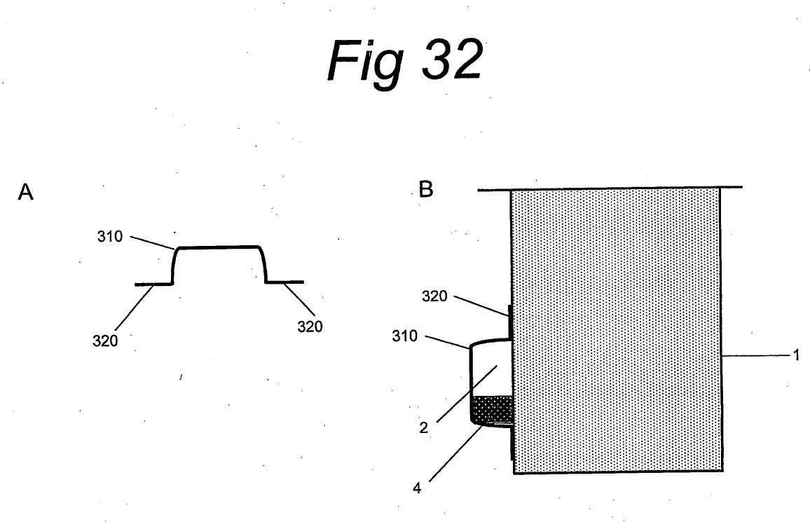

In an alternate method of manufacture, the container of this invention comprises a vessel portion having the shape of the final container. The additive chambers are formed by affixing an element to the outside surface of the vessel portion. The element is a single piece having a convex portion and a flange portion. The flange portion of the element is affixed to the outside surface of the vessel portion, thus allowing the convex portion to form a sealed additive chamber with the outer wall of the vessel. FIG. 32 shows an example of this method of manufacture. The chamber may be filled from the outside of the container or from the inside of the container. In another embodiment, the vessel portion comprises apertures over which the element is affixed. In this embodiment, the additive chambers may be filled from the inside of the container through the existing apertures.

In another embodiment, the container of this invention is a container comprising a separately manufactured top that is welded to the body of the container during manufacture, wherein the top has additive chambers on the underside of its top. One example of such a container is an aluminum can. In this embodiment, a series of chambers are created under the container top in any of a wide variety of patterns, such as pie segments, arrayed buttons, interlocking squares, rectangles or triangles, etc. The chambers are affixed to the underside of the container top, filled with additive and then sealed. The seal can be chosen from any of the materials previously described for manufacturing and additive chamber. For example, the seal may be a membrane or a foil sheet, the sheet comprising an element that is capable of opening when manual pressure. In certain embodiments, a foil sheet is preferred because it can advantageously be recycled with the aluminum can. The sheet is placed over the chamber with the opening element positioned over at least a portion of the chamber. The container top is then fused to the container body.

The container also comprises means for applying sufficient manual pressure to an additive chamber to cause said chamber to open and release the additive container therein into the base liquid. Any of the means described above can be employed in this embodiment. More specifically, such means include, but are not limited to, exposure of at least a portion of the additive chamber above the outer surface of the container top (where manual pressure of a finger can be applied), a lever-based mechanism exposed on the container top, a plunger-based mechanism exposed on the container top, or a piercing device associated with the container (i.e., a piercing straw). When sufficient manual pressure is applied to any of these means, the resulting pressure applied to the additive chamber is sufficient to break the seal and release the additive.

In yet another embodiment of the present invention the container additionally comprises an LCD or digital display. The LCD or digital display may indicate a temperature of the liquid in the container or which of the additive chambers has been opened by the user. In one example, an LCD display can indicate the temperature of the liquid by changing colors. In another example, a container of this invention comprises a hair dye base liquid and contains 5 different colorants as additives. Each colorant is present in five separate additive chambers. The 25 additive chambers are arranged in a 5×5 array with the chambers in each column in the array containing the same colorant additive. The container further comprises a digital display under each column of additive chambers. The digital display is in electrical communication with each of the additive chambers such that it senses when a chamber has been opened and registers the opening in a counter and produces the corresponding output as a display. Thus, if 1 chamber has been opened a “1” is displayed. If 2 chambers have been opened, a “2” is display and so on up to “5.” The adjustment of the color of the dye by the user through the addition of varying amounts of the 5 colorants, results in a 5 digit output being displayed. Once the user has produced a satisfactory dye color, the 5 digit number is recorded. The same color can be produced in another container of hair dye liquid containing the same colorants by opening the number of additive chambers corresponding to that 5 digit number.

In still another embodiment, the container of this invention additionally comprises a device for heating or cooling the base liquid prior to the liquid exiting the outlet. The device may be a sleeve that surrounds the container and comprises heating or cooling elements. In a separate embodiment, the invention provides a disposable liquid container comprising a vessel having a main chamber fillable with a base liquid and an inner vessel surface in physical communication with said main chamber, wherein at least a portion of said inner surface is coated with an additive selected from a colorant, a flavoring, a sweetener, a pharmaceutical, a nutrient, a creamer, tea, coffee, or an agent to promote mixing of said base liquid, wherein said additive is soluble in said base liquid. In a preferred embodiment, the additive is a flavoring, a sweetener, a creamer or a combination thereof and the liquid is an edible liquid. In a more preferred embodiment, the liquid is a tea or a coffee.

These additive-coated containers are preferably disposable and more preferably composed of styrene. In one aspect, different additive-coated containers may be stocked in a vending machine or otherwise offered for sale to a user. The user selects their choice of additive, is provided with the appropriately coated container and then fills the container with a base liquid either from the same vending machine or separately located. For example, containers coated with various flavorings compatible with coffee, optionally additionally coated with a creamer and optionally additionally coated with a sweetener are offered for sale to a user. The user is supplied with the chosen container that is then filled with brewed coffee providing the user with the selected flavored coffee.

According to another separate embodiment, the invention provides a disposable utensil comprising an outer surface coated with an additive selected from a colorant, a flavoring, a sweetener, a pharmaceutical, a nutrient, a creamer, tea, coffee, or a combination thereof, wherein said utensil is intended to be brought into communication with a base liquid, and said additive is soluble in said base liquid.

In a preferred embodiment, the utensil is a spoon or a stirrer. In another preferred embodiment, the utensil consists of materials that are soluble in said base liquid, such that the entire utensil dissolves in the base liquid. Such materials may be simply the same additive as on the outer surface of the utensil, one or more different additives, or another material.

In one aspect, different additive-coated utensils may be stocked in a vending machine or otherwise offered for sale to a user. The user selects their choice of additive, is provided with the appropriately coated utensil and a container filled with a base liquid either from the same vending machine or separately located. The utensil is used to stir the base liquid releasing into the base liquid the additive on the outer utensil surface. For example, utensils coated with various flavorings compatible with coffee are offered for sale to a user. The user is supplied with the chosen utensil and a container filled with brewed coffee. The user stirs the coffee with the provided utensil to produce the selected flavored coffee. The utensil may further comprise a sweetener or a creamer or both, wherein those additives are present in the same layer as the flavoring or in layers beneath the flavoring layer.

In still a different aspect of the invention there is provided a personalized beverage vending machine comprising: storage space for a plurality of bottles filled with the same base liquid; and storage space for a plurality of separately packaged additives, wherein said vending machine comprises selection means to allow a user to choose at least one of said additives in a single purchase; and wherein upon said purchase and said choice of additive said machine provides said user with a bottle of said base liquid and the at least one selected additive package. In a more preferred embodiment, the base liquid is water or carbonated water and the plurality of separately packaged additives comprises three, four, five, six or more different flavorants. Even more preferred is when the plurality of separately packaged additives additionally comprises caffeine. The caffeine may be offered in a package separate from said flavorants or together with certain of the flavorants. For example, such a machine may comprise a cola flavoring, a cola flavoring with caffeine, a lemon-lime flavoring, a root beer flavoring, a root beer flavoring with caffeine, a ginger ale flavoring, etc. Similarly, some additive packages may additionally comprise a natural sugar, while others may additionally comprise an artificial sweetener.

This machine advantageously keeps stock of any flavored beverage offered to the user longer than standard beverage vending machines. This is because each bottle of edible base liquid can be mixed with the appropriate additive to produce any of the choices offered by the machine. If there are as many additive packages of each additive offered as bottles filled with base liquid all offered choices are available until no bottles of base liquid are left. Such a vending machine requires restocking less often and always offers the user a full selection of choices.

The machine allows the vender to carry out a method of providing improved personalized beverage selection from a vending machine comprising the steps of: stocking said vending machine with a plurality of bottles filled with the same base liquid; stocking said vending machine with a plurality of separately packaged additives comprising at least four different individually packaged flavoring additives; offering for sale from said vending machine in a single purchase a bottle of said base liquid and a choice of one of said flavoring additive packages.

In a different embodiment, the invention provides a single composition of matter comprising a plurality of additives to be added to a base liquid wherein:

the plurality of additives comprises at least three different additives each independently selected from a colorant, a flavoring, a sweetener, a pharmaceutical, a nutrient, a creamer, tea, coffee, an agent to promote mixing of said base liquid and said additive, a carbonating agent or a preservative; and each additive is manually separable from another by a user.

In one preferred embodiment, the additives are all part of a solid bar or tablet with score line separating each additive from one another. The user breaks the bar or table on the score lines to separate and use the additives of choice. In an alternate preferred embodiment, the additives are separately packaged and each package is attached to another. The packages may be separated from one another with score lines or by cutting across a designated area between packages. This embodiment is similar to the packaging of dried active yeast. In yet another embodiment, the additives are packaged in a segmented tray, wherein the individual segments are sealed prior to first use. The user may unseal those additives that are desired for use. In certain versions of this embodiment, each camber comprises sufficient additive for multiple uses and a measuring scoop for removing a single serving portion of additive and each of the segments are separately resealable. In still another embodiment, the additives are packaged in a dispenser that is optionally sealable.

In another embodiment of this invention there is provided a kit consisting essentially of:

at least one container filled with an edible base liquid;

a plurality of additives to be added to the base liquid, wherein said plurality of additives comprises at least three different additives independently selected from a colorant, a flavoring, a sweetener, a pharmaceutical, a nutrient, a creamer, tea, coffee, an agent to promote mixing of said base liquid and said additive, a carbonating agent or a preservative; and

a holder for holding said container and said plurality of additives together in a single portable package.

In a preferred embodiment the plurality of additives is a single composition of matter, as described above.

In still another embodiment, the invention provides a programmable liquid container comprising:

a vessel having a main chamber fillable with a base liquid, an inner vessel surface in physical communication with said main chamber, an outer vessel surface, and a plurality of sealable outlets; and

a plurality of sealed additive chambers corresponding in number to the number of sealable outlets, each sealed additive chamber being in communication with one of said outlets and each sealed additive chamber comprising an independently selected additive, wherein:

each additive chamber is openable by a user when said vessel is filled with a base liquid by inserting a piercing device through an outlet into the vessel to open said outlet; and opening an additive chamber associated with said opened outlet by inserting said piercing device through said opened outlet, wherein opening an additive chamber places any additive contained therein in communication with said base liquid prior in said vessel.

The communication between the outlet and the additive chamber may be direct or indirect. Direct communication occurs when the additive chamber is attached to the underside of the outlet. Indirect communication may occur when the outlet and the additive chamber are connected by a conduit. The important aspect of this communication is that the piercing device first pierces the outlet and then upon further force into the vessel through the outlet, opens the additive chamber. Thus, it should be apparent that in this embodiment, the additive chamber may be present in the vessel without being in contact with either the inner or outer wall of the vessel. For example, it may be suspended in a conduit present in the vessel.

In certain embodiment the conduit containing the additive chamber is open to the base liquid and opening the additive chamber is sufficient to cause liquid communication between the additive and the base liquid. In other embodiments, the conduit is closed to the base liquid and must be opened, preferably also by action of the piercing device, to allow communication between the additive and the base liquid.

A preferred example of a piercing device useful in this embodiment is a piercing straw typically used to open drink boxes. Thus, the same device used to open the outlet, open the additive chamber and optionally allow liquid communication between the additive and the base liquid can also be used to consume the resulting mixture of base liquid and additive. In this, and optionally in several of the previous container embodiments of this invention, the device to open the additive chamber is associated with the container. The term “associated” means attached to the container, but not integrated into the additive chamber.

In order that the invention described herein may be more fully understood, the following examples are set forth. It should be understood that these examples are for illustrative purposes only and are not to be construed as limiting this invention in any manner.

### EXAMPLES

Reference will now be made in detail to certain preferred embodiments of the invention, examples of which are illustrated in the accompanying drawings. Wherever possible, the same reference numbers will be used throughout the drawings to refer to the same or like parts.

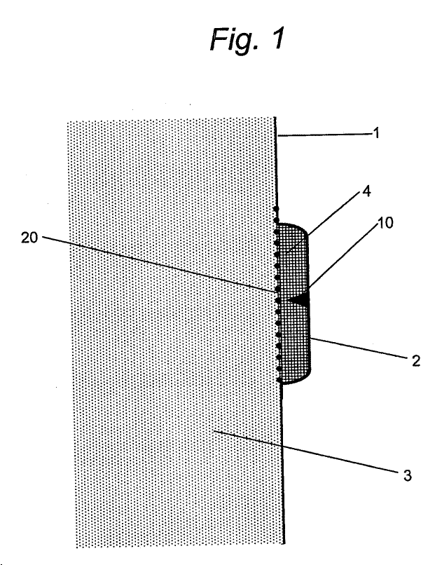

FIG. 1 shows a side view of a container of this invention filled with a liquid 3. The container comprises a button-shaped additive chamber 2 filled with an additive 4. The additive chamber is affixed to the vessel wall 1. The additive chamber 2 further comprises an integrated piercing device 10. When the additive chamber 2 is depresses by the user, the piercing device 10, breaks through a frangible seal 20 which serves as a common wall for the vessel and the additive chamber 2. When the piercing device 10 breaks through the frangible seal 20, the additive chamber contents 4 are released into the liquid 3. The button shaped additive chamber 2 may be filled with additive 4 before the vessel is filled with liquid 3 or even before the vessel is constructed. The frangible seal 20 is placed on the end of the additive chamber 2 sealing in the additive 4. The chamber 2 is then sealed to the inner surface of the vessel via an adhesive, heat welding or another method of attachment forming a continuous wall with the wall of the vessel 1.

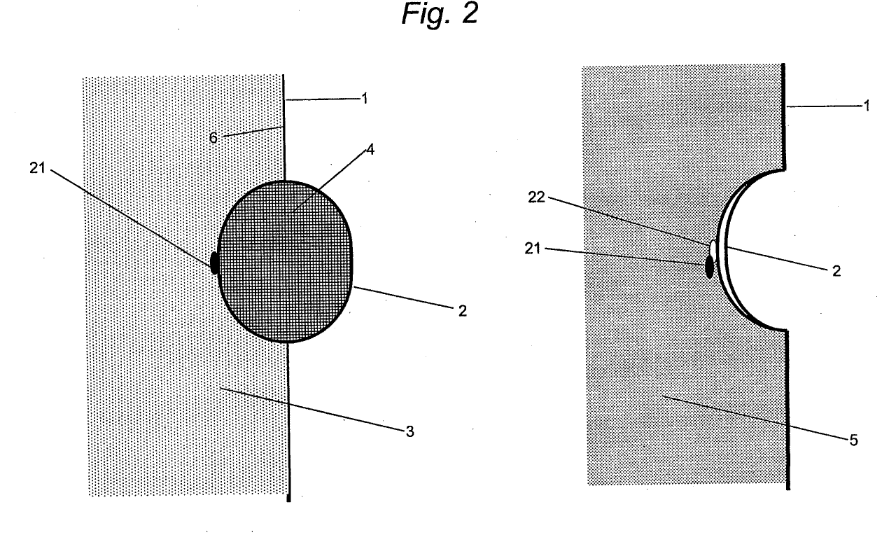

FIG. 2 shows a side view of an alternate embodiment of an additive chamber construction. In panel A, the additive chamber 2 containing additive 4 is sealed with a plug 21 and is in communication with both the inner 1 and outer wall 6 of the vessel which contains liquid 3. The user presses the additive chamber 2 until the chamber collapses to form a concave depression on itself, as shown in panel B. The force of depressing the chamber forces the plug 21 to open allowing the additive to escape the additive chamber 2 through the aperture 22 formerly covered by plug 22. This produces a mixture containing the liquid and the additive 5. The additive chamber 2 remains depressed to indicate that the additive 4 has been released.

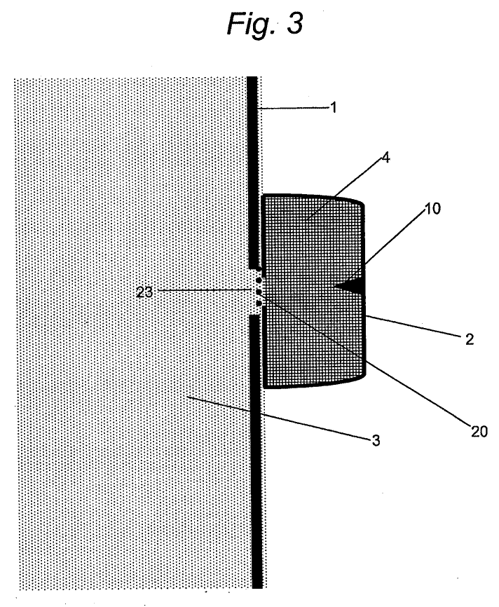

FIG. 3 shows a side view of another embodiment of additive chamber construction. In this embodiment, the vessel wall 1 contains an aperture 23. The additive chamber 2 is affixed to the outer wall of the vessel covering the aperture 23, thus preventing the unwanted escape of liquid 3. The portion of the chamber 2 covering the aperture 23 is a frangible seal 20. The chamber 2 also comprises a piercing device 10. When the chamber 2 is depressed by the user, the piercing device 10, breaks the frangible seal 20 allowing the additive 4 to escape the chamber 2 through the aperture 23 and mix with the liquid 3.

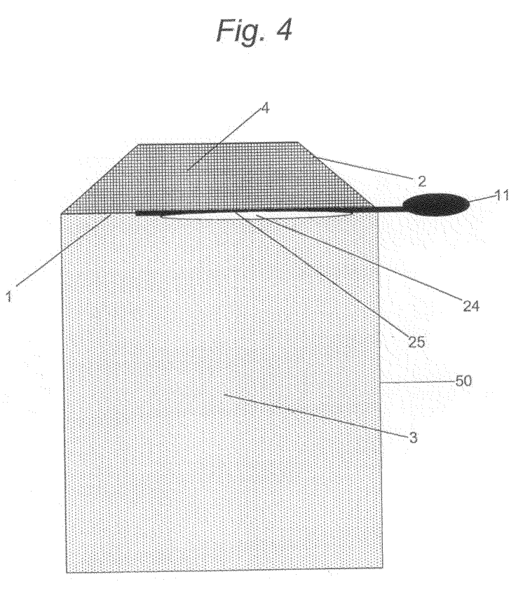

FIG. 4 depicts a container 50 with an aperture 24 between the additive chamber 2 and the vessel wall 1. The aperture 24 is covered by a movable door 25 that may be opened by the user by pulling a pull-tab 11 attached to the door 25. Once the door has been removed, the additive 4 in chamber 2 is brought into communication with the liquid 3 in the vessel.

FIG. 5 depicts a side view of a container 50 filled with a liquid 3 and comprising a piezoelectric additive dispenser. The dispenser comprises multiple additive chambers 2a, 2b and 2c filled with different additives 4a, 4b and 4c. The release of a specific additive is controlled by the user through a keypad or series of buttons 41. The selection of a button is translated by a microprocessor 30 powered by a power supply 42 into the opening of the corresponding electrically controlled jet 43a, 43b or 43c and the release of the corresponding additive 4a, 4b or 4c into liquid 3.

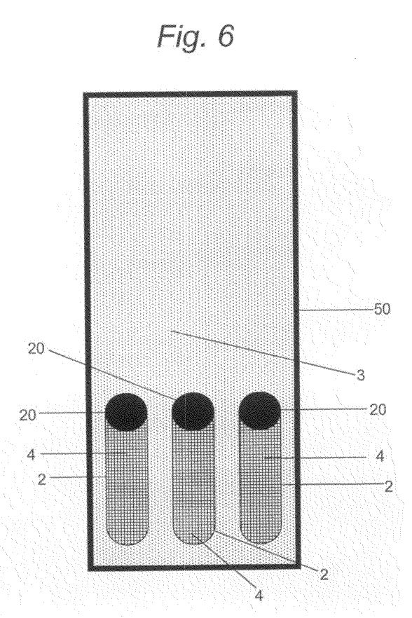

FIG. 6 depicts a flexible container 50 comprising a base liquid 3. Within the container 50 resides three rigid, breakable additive chambers 2 each comprising an additive 4 and each having a frangible seal 20. The user applies force to the additive chamber 2 such as by pinching through the walls of the flexible container 50. This causes the frangible seal 20 to break and release the additive contents 4 into the liquid 3.

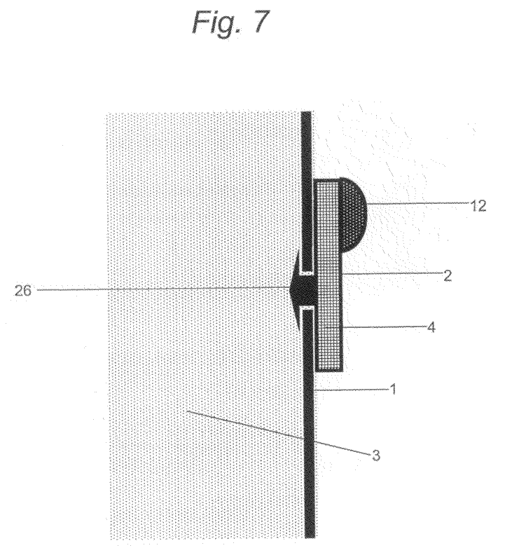

FIG. 7 depicts a side view of yet another embodiment of additive chamber construction wherein an additive chamber 2 is affixed to the outer vessel wall 1 of the container. In this embodiment, the chamber 2 contains multiple doses of additive 4. A dose of additive 4 is released from the chamber 2 into the vessel by means of a pump bulb 12. The additive 4 is released through a hole in the vessel wall closed by a one-way valve 26 that opens as a result of pressure forced upon it caused by depression of the pump bulb 12.

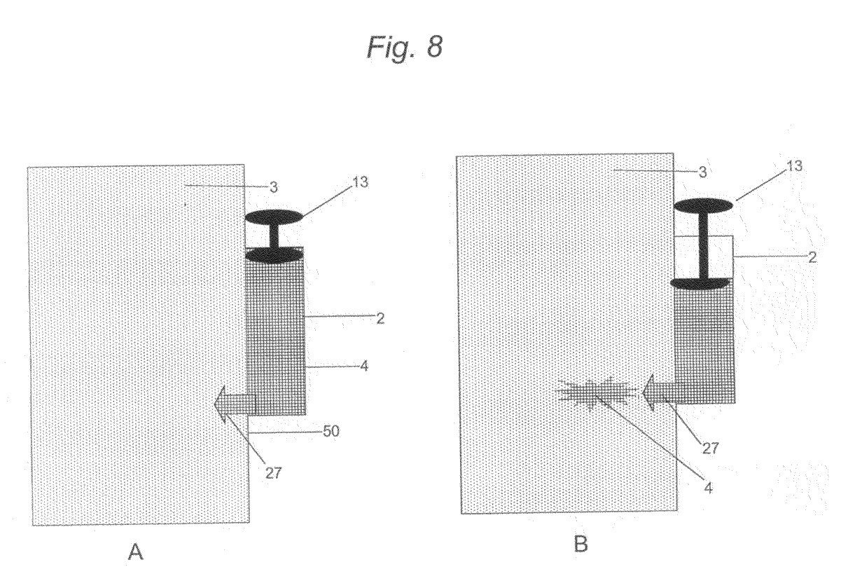

FIG. 8, panel A, shows a side view of yet another additive chamber construction. In this container 50, an additive chamber 2 is attached to the wall of the vessel and is filled with multiple doses of an additive 4. The additive 4 is placed in communication with the liquid 3 filling the vessel through a pressure activated opening 27 in the chamber 2 controlled by a ratcheting plunger 13. In panel B, a single dose of additive 4 has been released through the pressure activated opening 27 after the ratcheting plunger 13 has been depressed. This particular embodiment is well suited when the liquid 3 is gasoline and the additive 4 is oil.

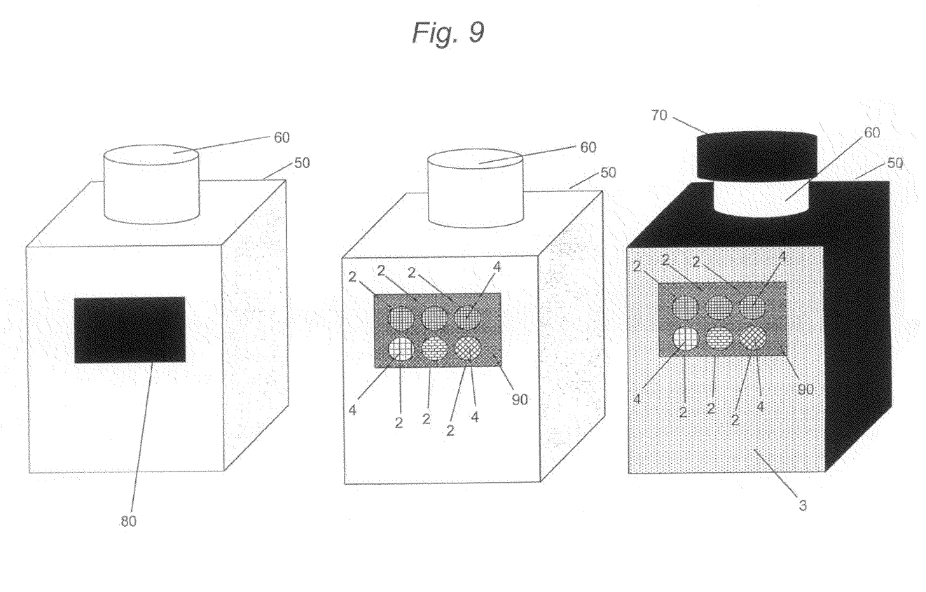

FIG. 9 depicts various stages in the manufacture of a container 50 comprising an outlet 60 and multiple additive chambers 2 stored in a blister pack 90. In panel A, prior to being filled with a liquid, the container 50 contains an opening 80 to receive the blister pack containing the additive chambers. The opening 80 is may be molded into the container 50 or cut into the container 50 after welding. In panel B, a blister pack 90 comprising multiple additive chambers 2 filled with the same or different additives 4 has been affixed and sealed over the opening 80 by adhesive or heat welding. In panel C, the container 50 has been filled with a liquid 3 and sealed with a cap 70.

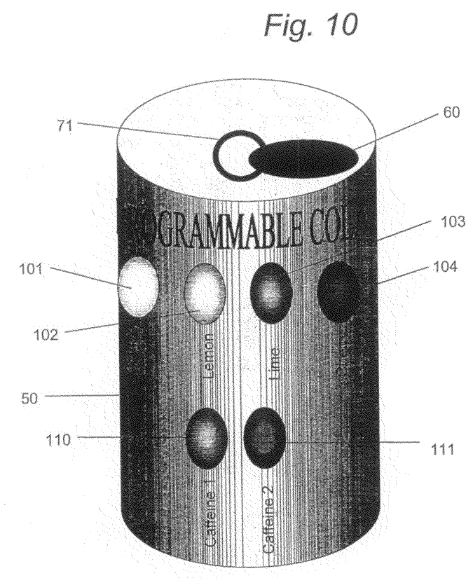

In FIG. 10 the container 50 is an aluminum can typical of that used with carbonated beverages filled with a cola beverage. The outlet 60 is sealed with a ring tab 70 (or alternatively with a lever-like piercing device that opens the outlet when engaged by the user. The container 50 comprises an additive chambers separately filled with a vanilla flavorant 101, a lemon flavorant 102, a lime flavorant 103, a cherry flavorant 104, and two separate chambers each filled with caffeine 110 and 111.

The caffeine chambers 110 and 111 allow the user to choose one dose or two doses of caffeine if each chamber contains the same amount of caffeine. However, in one embodiment chamber 110 contains one dose of caffeine and chamber 111 contains two doses of caffeine. This allows the user to choose four different levels of caffeine to release into his cola (none, one, two, or three). The four optional levels of caffeine combine with typically desirable combinations of flavor additives (none, vanilla only, lemon only, lime only, cherry only, lemon and lime, or cherry and vanilla) to yield 28 potential combinations of cola from this single container.

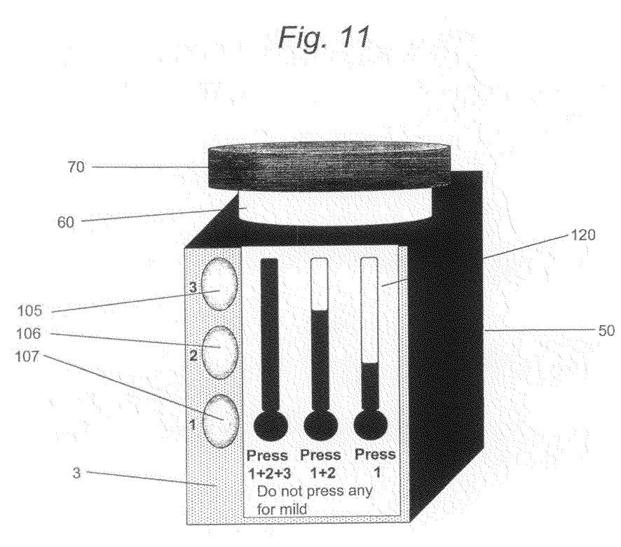

FIG. 11 depicts a container 50 filled with salsa or tomato sauce 3. The container 50 comprises an outlet 60 sealed with a cap 70 and three additive chambers each containing the same amount of hot pepper sauce 105, 106, and 107. The user can regulate the spiciness of the sauce or salsa 3 by opening none, one, two or all three of additive chambers (105, 106, and/or 107). The container 50 also includes a label 120 guiding the user as to how to adjust the spiciness of the liquid 3.

Alternatively, the amount of hot pepper sauce in each button can escalate. A preferred pattern of escalation is exponential, e.g., one dose, two doses, four doses. This allows the user to choose any amount in a linear progression of dosing by considering all permutations of buttons. For example, if button 1 107 has one dose, button 2 106 has two doses, and button 3 105 has four doses, the following combination apply: none; button 1=1 dose; button 2=2 doses; buttons 1 and 2=3 doses; button 3=4 doses; buttons 3 and 1=5 doses; buttons 2 and 3=6 doses; buttons 1, 2 and 3=7 doses.

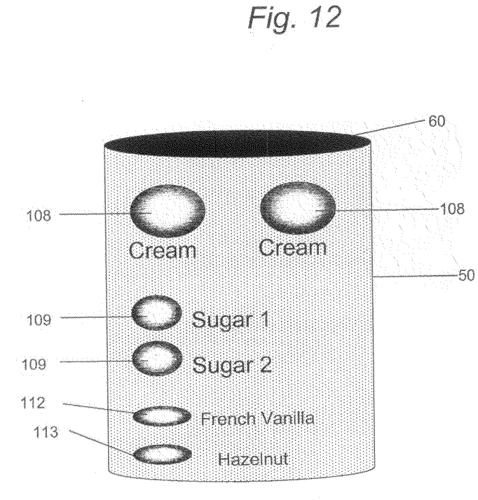

In one specific embodiment of the invention, a disposable container for coffee is provided as shown in FIG. 12. The container 50 has an outlet 60 and two additive chambers containing cream 108, two chambers containing sugar 109, as well as one additive chamber containing the flavorant French vanilla 112 and one chamber containing the flavorant hazelnut 113. Any combination of the flavorants, cream and sugar can be released into the chamber by depressing the appropriate button either prior to or after the container 50 has been filled with coffee. A similar design can be used for a cup of soup, wherein salt, pepper, herbs, and/or spices replace the cream, sugar and flavorant chambers.

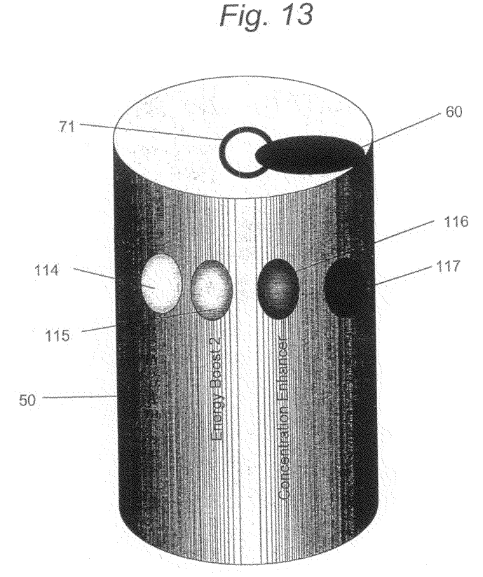

In one specific embodiment shown in FIG. 13, the container 50 is an aluminum can filled with an edible liquid base to create an energy/health drink. The container 50 comprises an outlet 60 that is closed via a ring tab 71 that can be opened by the user. The container 50 consists of four different additive chambers containing two different energy boosting additives 114 and 115, an additive that is a concentration enhancer 116 and an additive that is an immunity enhancer 117, respectively. The user can release none, one, two, three or all four of the additives into the liquid base before or after opening the ring tab 71 and consuming the resulting beverage.

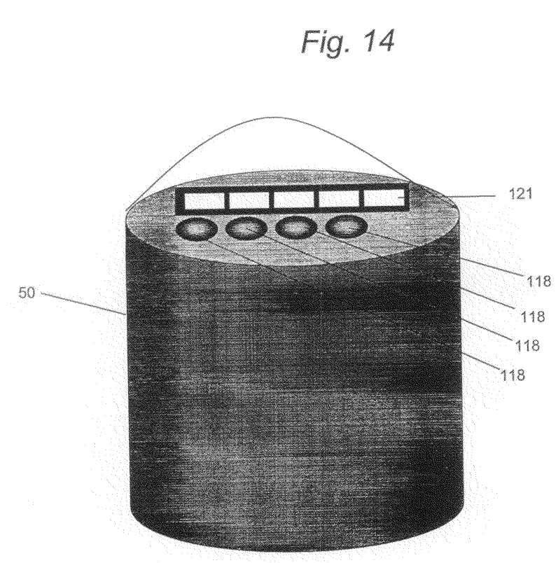

Another specific embodiment of a paint container of this invention is shown in FIG. 14. The container 50 is a paint can typically containing a white or light colored paint base. The can comprises four additive chambers 118 containing the same pigment that allow the user to darken the color of the paint. The color of the base paint is indicated on the rightmost section of the swatch 121 that is included with the container.

The swatch 121 also indicates the darker shades that may be achieved by releasing the pigment from one, two, three or all four of the additive chambers 118. The base paint color is tested on a small part of the wall. If darkening is desired, one of more additive chambers 118 are opened by manually pressing on the chamber, yielding discreet and reproducible incremental color changes. The swatch 121 can either be separate from the can, or attached to the top.

A different paint container is depicted in FIG. 15. This container 50 comprises and outlet 60 sealed with a cap 70. The container 50 is filled with a white paint base 3.

Additive chambers containing 1× 122, 2× 123, 4× 124, 8× 125 and 16× 126 amounts of magenta 130, cyan 131, yellow 132 and black 133 pigments are part of the container 50. With these varying amounts the user can select any number from 0× to 31× of any of the four pigments to add to the white base. This yields 32⁴ combinations or over one million possible colors from a single container. The container may optionally comprise a swatch or series of swatches that would indicate the colors produced by the different combinations of pigment chambers opened.

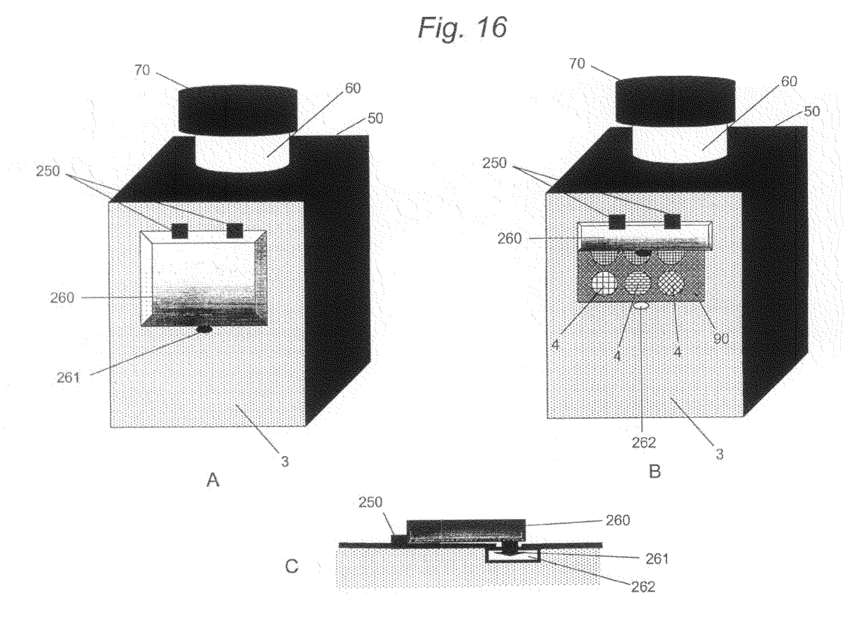

A specific embodiment demonstrating a protective covering for additive chambers associated with a container is shown in FIG. 16. This embodiment is particularly useful for pharmaceutical additives and to prevent unwanted release of additives into the liquid. Panel A shows a container 50 comprising an outlet 60 sealed with a cap 70. The container 50 is filled with a edible liquid base 3. A cover 260 that is secured to the container 50 by a pair of hinges 250 prevents access to the additive chambers 2. The cover 260 comprises a latch 261 that reversibly locks into place by inserting into an opening 262 shown in panel B. Panel B shows the cover 260 pulled up to reveal the additive chambers 2 contained in a blister pack 90. Panel C shows a side view of the cover 260 attached to the container via the hinges 250 with the latch 261 locked into place into the opening 262 in the container.

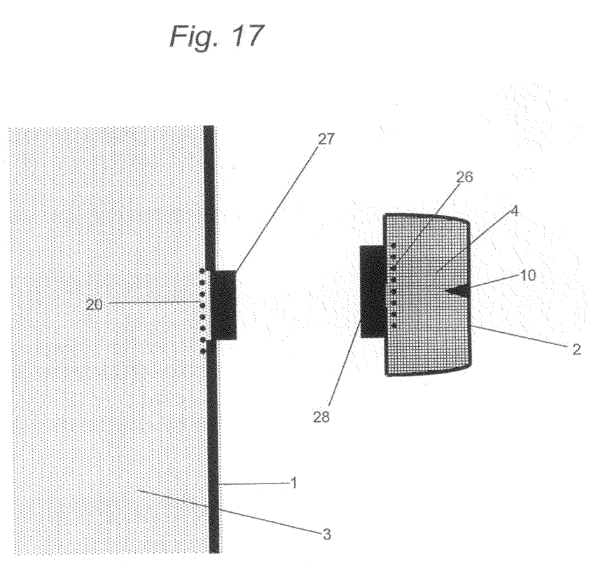

Another embodiment of additive chamber construction is demonstrated in FIG. 17. The additive chamber 2 is a screw-cap type structure. The additive chamber comprises an integrated piercing device 10 and is sealed with a frangible seal 26. The additive chamber 2 also contains a male fitting 28 that is designed to fit onto a female fitting 27 situated on the outer vessel wall 1. The vessel also contains a frangible seal 20 beneath the female fitting to seal the vessel wall prior to attachment of the additive chamber 2. The additive 4 may be released into the liquid in the vessel 3 by screwing the additive chamber onto the vessel, which causes the piercing device 10 to break frangible seals 26 and 20. In an alternative embodiment, the user has to manually depress the additive chamber 2 after it is attached to the vessel in order to cause the piercing device 10 to break frangible seals 26 and 20.

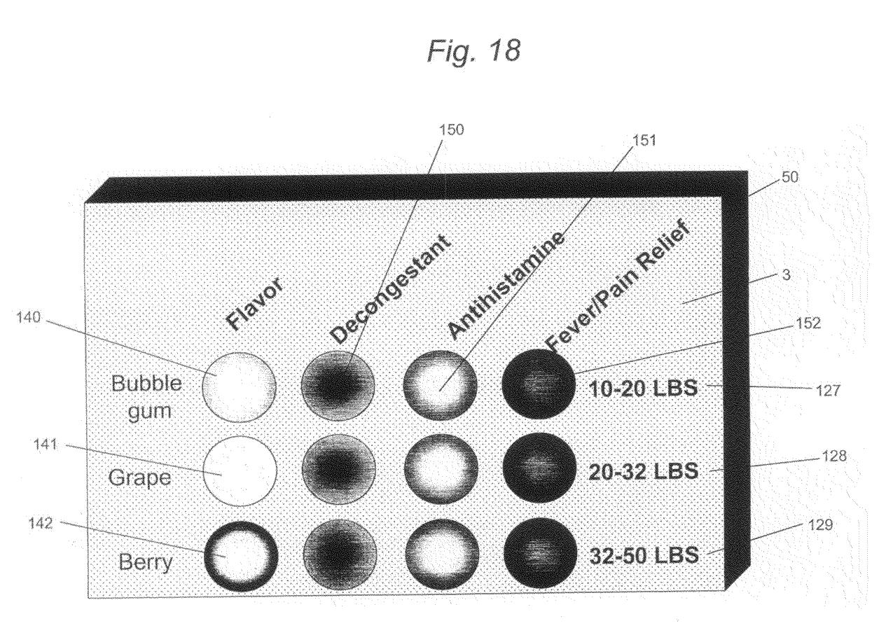

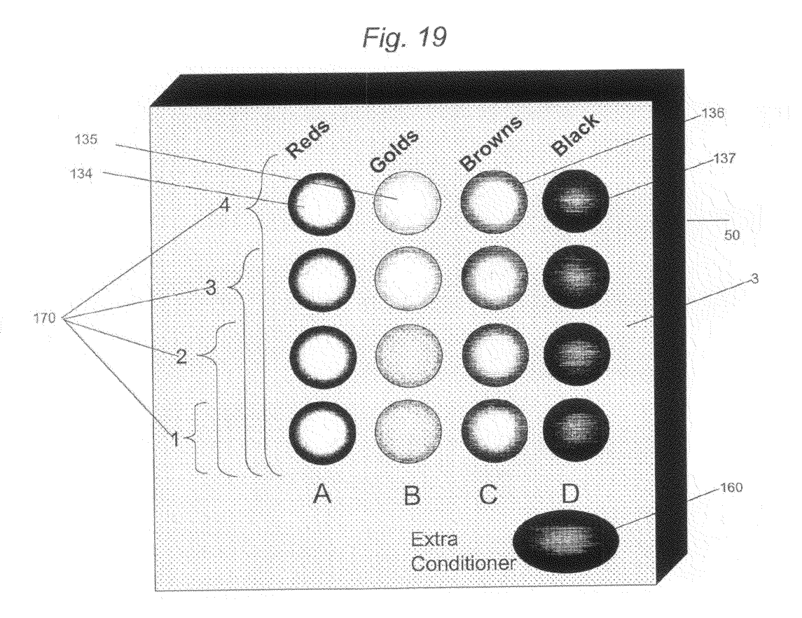

A container for children's over the counter medicine is depicted in FIG. 18. The container 50 comprises a edible base liquid 3 suitable. The container 50 comprises additive chambers containing a bubble gum 140, grape 141 and berry 142 flavorant, as well as three additive chambers of each of a decongestant 150 an antihistamine 151 and a fever/pain reliever 152. The container indicates that one additive chamber is the proper dosage for a child weighing 10-20 lbs 127; two additive chambers is appropriate for a child weighing 20-32 lbs 128; and that all three chambers should be opened for a child of 32-50 lbs 129. The care-giver can flavor the liquid to the child's liking and add the appropriate pharmaceutical for the child's symptoms and size. This single container provides numerous options for treatment of various cold, flu and allergy symptoms. FIG. 19 depicts a single use container 50 comprising a hair coloring base liquid 3 and multiple additive chambers containing red 134, gold 135, brown 136 and black 137 hair dyes. The container also comprises an additive chamber containing a hair conditioner 160. The container 50 also contains cumulative dosing instructions 170 to guide the user, e.g., level 1 is achieved by opening chamber 1, level 2 by opening chambers 1 and 2, and so on. The amount of dye in each chamber containing a given color may be equal, escalating, or decreasing for each successive chamber in a column, depending on the desired dosing increments. The example hair dye pigments are simply one possibility. The pigments could all be from one class (e.g. browns) to give more variations in the brown dimension, with less breadth. If the amount in each chamber is different, then alternative or additional instructions could suggest more complex patterns of chamber opening to obtain a greater range, and more increments. Other non-colorant chambers, such as a curling agent, or the extra conditioning agent shown 160 may be included.

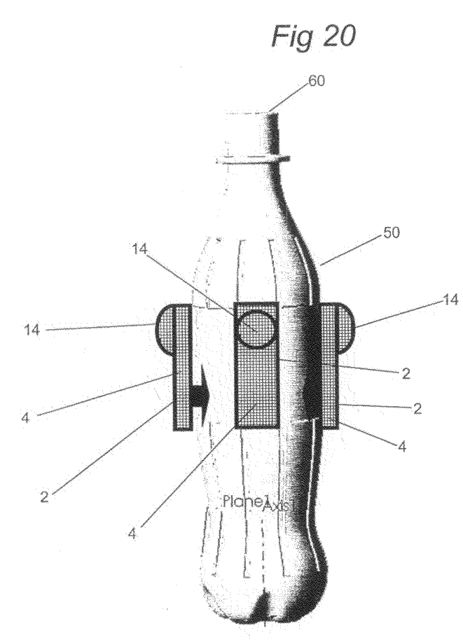

FIG. 20 shows a three-dimensional rendering of a refillable container 50 that has 3 additive chambers 2, each with an injector button 14 that dispenses only a portion of the additive 4 contained within the chamber. By pressing the injector button 14 once (or several) times an amount of highly concentrated additive 4 is released to create a liquid that can be poured or drunk out of the container outlet 60. Each of the additive chambers 2 can have a different flavor or character of additive 4. For example, each chamber 2 could contain enough artificial sweetener, color and flavor, to make 6 containers full of a different flavored (and/or colored) drink from a water base liquid. In one example, one of the chambers 2 is an artificially sweetened, yellow, lemon drink concentrate, another is an artificially sweetened, green, lime drink concentrate, and the third is an artificially sweetened, red, cherry drink concentrate. When said flavored drink is consumed, the container is refilled with water, and another flavored drink, either the same or different can be created. Thus, a single contained could create 18 bottles full of drinks. This would reduce packaging material consumption, while allowing the consumer to have a variety of flavors. There may be from one to 12 additive chambers containing the same or different flavors, each enough for between 1 and 24 fillings of the vessel, but preferably 1-8. The individual components of the drink (flavor, color, sweetener, caffeine) can also be partitioned into different additive reservoirs, to give the user even more control over the composition of the drinks.

In FIG. 21 the container 50 comprises a main chamber filled with base liquid 3 and a mixing chamber 180 located at or near the outlet 60. Both the main chamber and the additive chambers 2 are connected to the mixing chamber 180 via a conduit 190 such as tubing. The flow of the additives 4 is adjustable by valves or a valve block as described in the text. A wheel or dial with increment markings (not shown) can be employed to allow the user to choose the ratio of the various additives.

In some alternate embodiment only a single additive chamber is present and the user can vary the amount released into the base liquid. This would be a preferred embodiment for a sun tan lotion base liquid with a sun block additive, or for a mosquito repellant base liquid with the active repellant (such as DEET), as the additive. In an embodiment where the base liquid is a sun tan lotion, a traceable dye, which is known in the art and useful to assess coverage of the body with the lotion, could be an additional additive.

The method of releasing the base liquid mixed with the additive from the mixing chamber could be squeezing in the case of a flexible tube liquid container (wherein the liquid may be a gel or a cream), a pump sprayer, an aerosol spray head in the case of pressured container), or any other known liquid releasing device. The mixing chamber 180 can also be contained within the liquid releasing device. One-way valves may be utilized at the point where the additives enter the mixing chamber, to prevent back flow. The arrangement shown in FIG. 21 is also well-suited for base cleaning liquids, where the additives are different scents, and/or different cleaning enhancers. It is also well suited for base car polishing liquids, or other liquids that are typically mixed with abrasive particles. In this embodiment, the additive chambers would contain varied sizes of abrasive particles. This would be particularly useful, because during the cleaning or polishing process, the user typically begins with coarse grains, and finishes with finer grains.

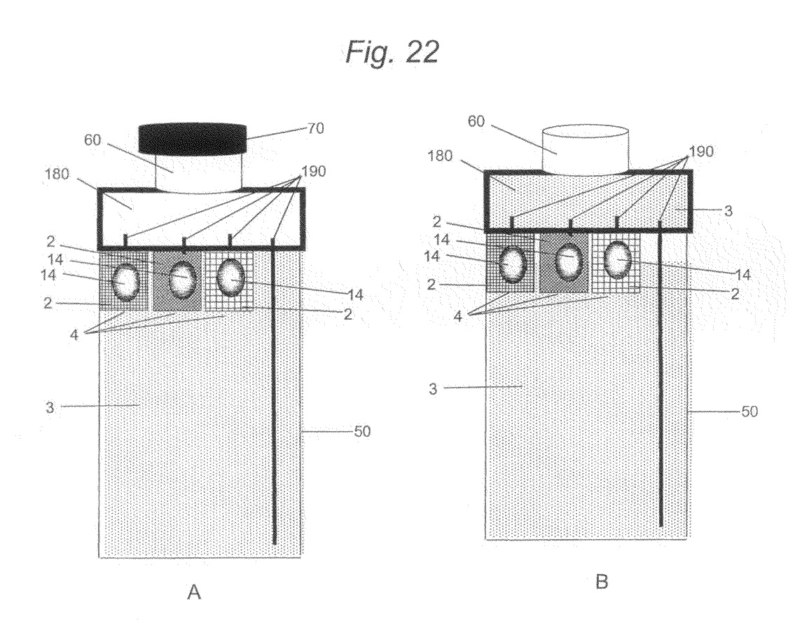

A different mixing chamber construction is shown in FIG. 22. In panel A, the container 50 comprises a main chamber filled with a base liquid 3 and a mixing chamber 180. The additive chambers 2, as well as the main chamber are connected to the mixing chamber via conduits 190. The additive chambers 2 contain multiple doses of additive 4 that are dispensed one dose at a time into the mixing chamber through the use of an injector button 14. As shown in panel B, a discrete aliquot of base liquid 3 is pumped or otherwise dispensed (e.g., by inverting the container while the cap 70 is in place over the outlet 60) into the mixing chamber 180. The desired additives 4 are also dispensed into the mixing chamber 180 by manually depressing the injector button 14 to produce a wide variety of different combinations of base liquid and additive at each use. The conduits 190 are preferably fitted with one-way valves or similar devices to prevent flow from the mixing chamber into the additive chambers or into the main chamber.

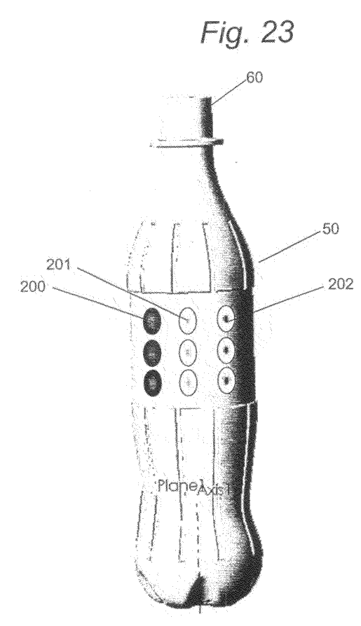

The three dimensional rendering of the container 50 in FIG. 23 is similar to the container shown in FIG. 20. However, in this container each set of three additive chambers 200, 201 and 202 contains an actual or potential component of the standard base liquid rather than a purely optional flavor, or color. In this Figure the base liquid is a cola beverage, and each set of three additive chambers contains a cola ingredient. The base liquid cola has a low amount (or none) of each of these cola ingredients. If all three additive chambers containing a particular component are opened, the user obtains a cola beverage having a very high level of the corresponding cola ingredient. In a preferred embodiment, the concentrations in each of the three additive chambers containing the same component would be progressively higher so than many more levels of additive could be achieved (see, for example, the arrangement of additive chambers in FIG. 15).

In this example, if each set of three additive chambers contained 1, 2 and 4 units, respectively of a cola component, 512 different characters of cola could be created. This is exceptionally useful, as currently Coca-Cola® and Pepsi® debate which of their cola formulas is preferred by consumers. While these cola manufacturers may claim a higher percentage of people prefer their formula, hundreds of millions of customers clearly prefer one or the other formula. In fact, several years ago Coca-Cola® launched a new cola formula that was unsuccessful because many of their customer preferred the old cola formula. This design depicted in FIG. 23 allows consumers to generate their favorite formula from the same container. The novelty and fun associated with programming the bottle will also provide an entertainment factor, particularly to youthful consumers.

For other edible base liquids, it should be noted that there are only a small number of flavors detectable by the tongue (salt, sweet, sour, bitter and unami, hot), while the rest are ordinarily perceived through the sense of smell. A wide variety of flavor characters could be obtained by using between 2 and 5 of these tongue-detectible flavors in the additive chambers, along with separate additive chambers containing more smell-based flavors that are compatible to the base liquid.

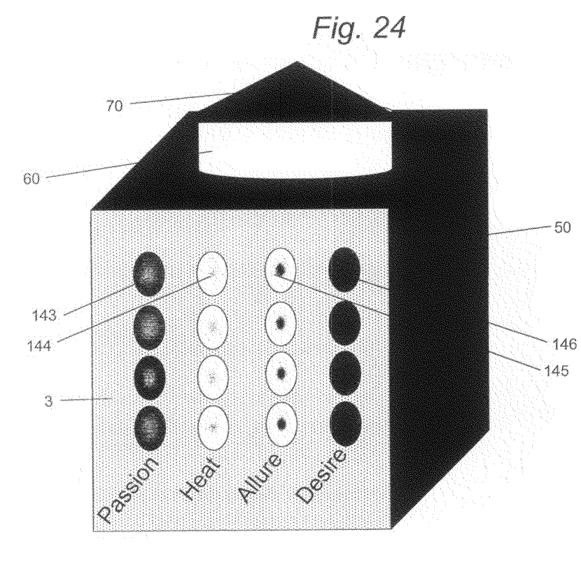

In FIG. 24, the container 50 comprises a base liquid 3 is a perfume base with or without a base level of scent components. The container 50 comprises an outlet 60 and a cap 70. The sets of additive chambers 143, 144, 145, and 146 provide user-programmable amounts of a number of scent additives (fragrance additives). The 4 different additives contained in four additive chambers each shown in this FIG. 24 can produce 5⁴ (0, 1, 2, 3 or 4 doses of each of the four fragrances) or 625 different combinations, if each additive chamber containing the same scent additive has identical quantities. Using escalating amounts of each scent additive (1×, 2×, 4×, 8×), such as that depicted in FIG. 15, can provide the user with 16⁴ or over 60,000 combinations.

Each fragrance additive type could be associated with an emotional dimension corresponding to the feelings the fragrance additive purportedly evokes. Sets of questions could be used to assess the users personality type or desired effect and to direct the user as to what combinations of additive chambers to open. Also, manufacturers can give individual scent names to the opening of pre-set, discrete combinations of additive chambers.

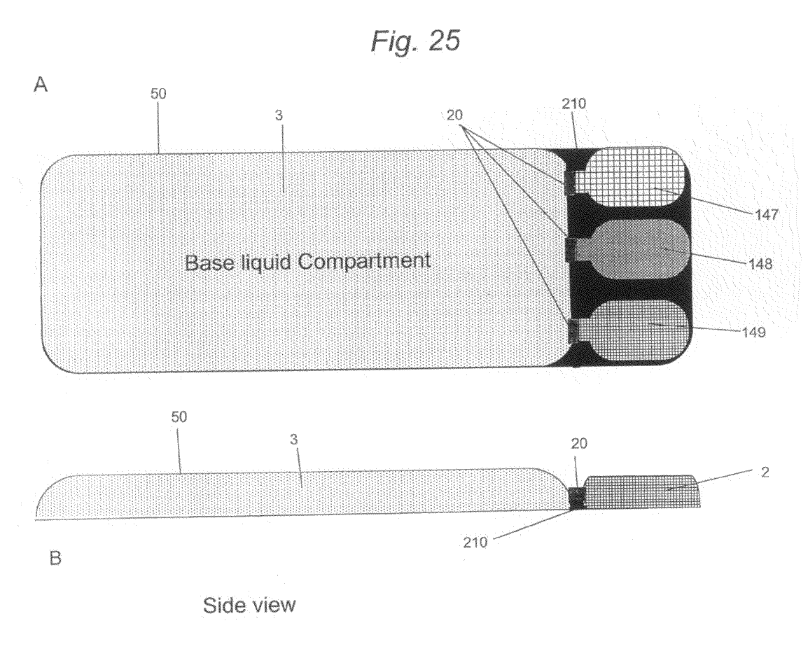

FIG. 25 depicts a programmable flexible container 50 of this invention, preferably an intravenous bag. Panel A shown the flexible container 50 filled with a liquid 3. Additive chambers 147, 148, and 149 contain different additives. The additive chambers are contained within a compartment 210 that is attached to the vessel by an adhesive or heat seal. The opening of the additive compartment is separated from the base liquid 3 by means of a frangible seal 20 that is designed to break upon the application of pressure onto the additive chamber. Panel B shows a side view of the flexible container 50, wherein one additive chamber 2 is attached to the vessel by a seal 210 and is separated therefrom via a frangible seal 20.

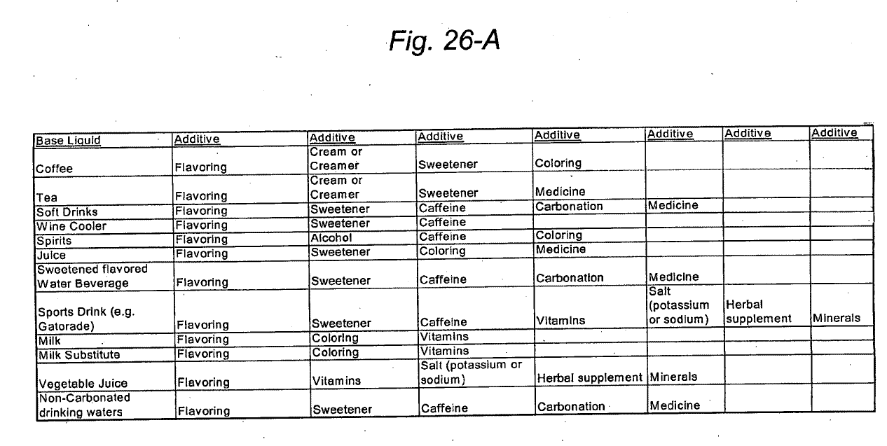

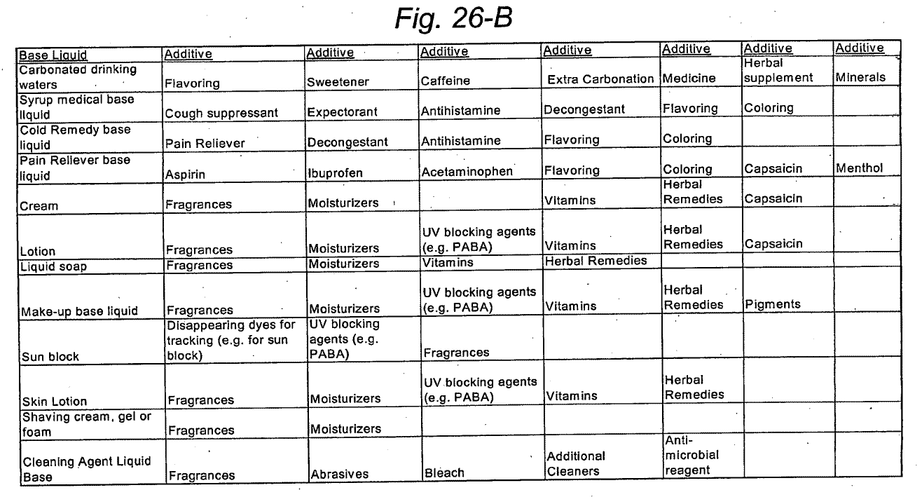

FIGS. 26-A to 26-B set forth for specific base liquids the different preferred additives to be included in the additive chambers present in the container of this invention. It is preferred that at least two, three, four or more of the listed additives be present with the specified liquid. It is most preferred that all of the listed additives be present with the specified liquid. It should be understood that additives in addition to those listed in FIGS. 26-A to 26-B may also be present with these base liquids. It should also be understood that any one of the listed additives may be present in a single additive chamber or in separate multiple additive chambers and that when present in separate multiple additive chambers, the amount of additive in each of those multiple chambers can be the same or different. In an alternate embodiment more than one of the listed additives may be combined in a single additive chamber.

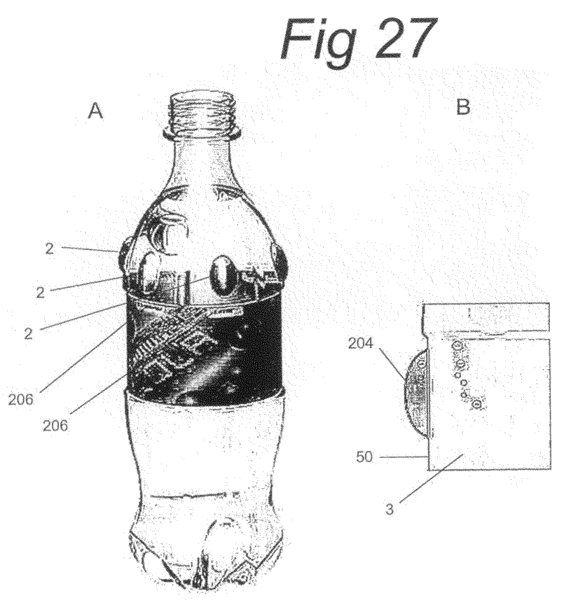

FIG. 27, panel A, depicts a design of a container of the present invention. The vessel is a plastic bottle fillable with a cola. The container has button-type additive chambers 2 fused to the vessel and arranged equidistant from one another around the circumference of the upper portion of the vessel with a label 206 indicating the additive present in each chamber. Panel B depicts a side view of the container 50 in panel A, showing a button-type additive chamber comprising a cherry flavorant 204 which when depressed by the user releases the additive into the base cola liquid 3.

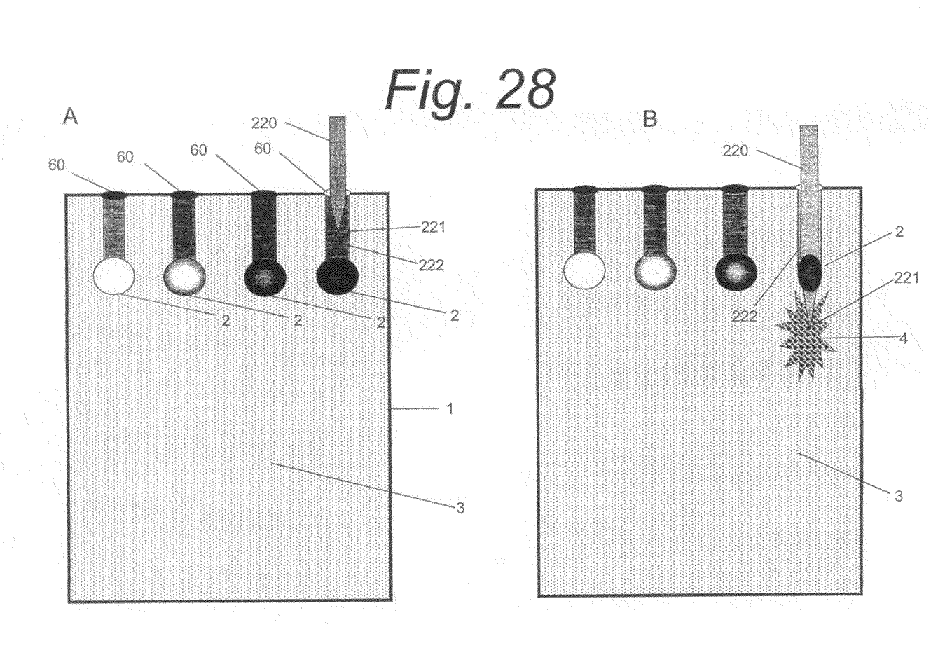

FIG. 28 depicts cutaway views of a specific container of the invention 1 containing a base liquid 3, multiple outlets 60 and additive chambers 2 associated with each outlet. Each additive chamber 2 is connected to an outlet 60 by means of a conduit 222. In panel A, a user has inserted a piercing straw 220 through outlet 60 using its sharp tip 221. In panel B, the user has moved the piercing straw 220 down through the conduit 222 to pierce the additive chamber 2, causing release of the additive 4 into the base liquid 3.

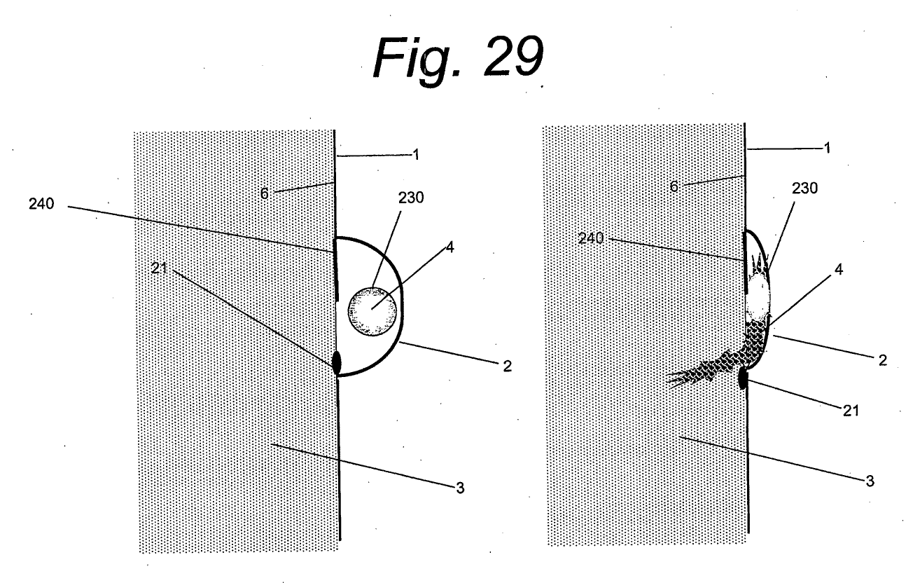

FIG. 29 depicts a side view of a specific container 1 of this invention. In panel A, The additive chamber 2 comprises a frangible holder 230 in which an additive 4 is stored. The additive chamber 2 also comprises a rigid portion 240 on its inner wall and a plug 21 which seals the chamber from the base liquid 3 present in the vessel. In panel B, a user applies manual pressure to the outer wall of additive chamber 2 forcing the frangible holder 230 against the rigid portion of the inner chamber wall 240. This causes the frangible holder 230 to break and release the additive 4 into the chamber. The same force also causes the plug 21 to open and allow the additive 4 released into the additive chamber 2 from the frangible holder 230 to now flow into and mix with the base liquid 3.

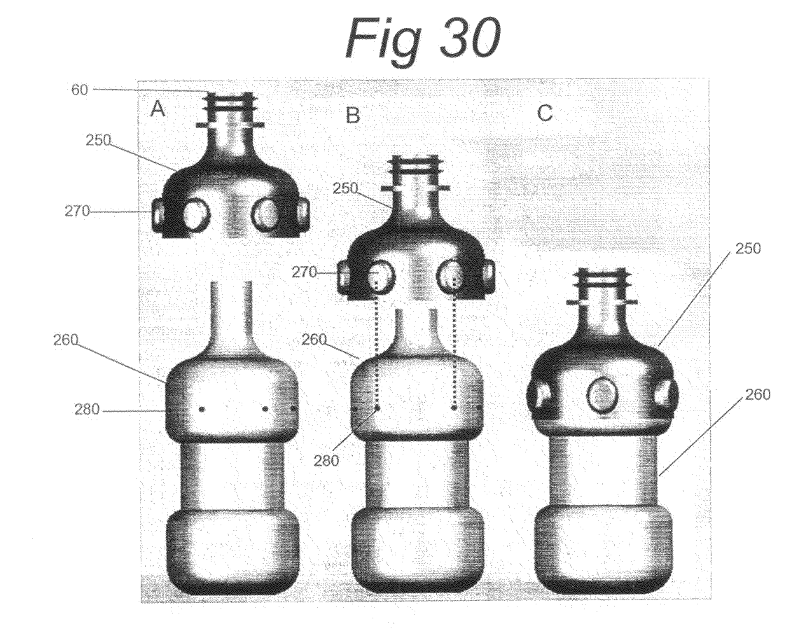

FIG. 30 depicts a method of manufacture of a specific embodiment of this invention. Panel A depicts an outer piece 250 corresponding in shape to the top of a container and comprising outward protrusions 270 and an outlet 60; and an inner piece 260 corresponding in shape to the entire container. The inner piece also comprises apertures 280. Panel B show the outer piece 250 being fitted over the inner piece 260 so that the apertures 280 align with the protrusions 270. Panel C depicts the assembled container with the outer piece 250 fused to the inner piece 260. The apertures are underneath the protrusions and provide a means for loading the additive chambers formed by the protrusions and the inner piece with additive from the inside of the container.

FIG. 31 depicts another method of manufacture of a specific embodiment of this invention. Panel A depicts a cutaway view of a portion of a container 1 lying on its side. The container is manufactured with a protrusion 290 extending outward from the container. Panel B depicts the same container wherein the protrusion has been filled with additive 4 and then sealed with a membrane 300 to form a filled and sealed additive chamber. Additional protrusions existing on said container may be similarly filled and sealed by rotating the container.

FIG. 32 depicts another method of manufacture of a specific embodiment of this invention. Panel A depicts a an element comprising a convex portion 310 and two flanges 320. Panel B depicts the assembly of the element shown in panel A onto a container 1 to form an additive chamber 2. The flanges 320 are welded onto the outside surface of the container 1. This allows an additive chamber 2 to be formed between the convex portion of the element 310 and the outer wall of the container. In panel B, the additive chamber 2 has been partially filled with additive 4.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A programmable liquid container comprising:
a vessel having a main chamber fillable with a base liquid, an inner vessel surface in physical communication with said main chamber, an outer vessel surface, and a sealable outlet; and
a plurality of sealed additive chambers each comprising an independently selected additive, each additive chamber having an inner chamber surface and an outer chamber surface, wherein:
said outer additive chamber surface is in physical communication with said vessel; and
said additive chamber is manually openable by a user when said vessel is filled with a base liquid and said outlet is sealed, and wherein opening an additive chamber places any additive contained therein in communication with said base liquid in said vessel and does not disrupt the integrity of the sealed vessel.

2. The container according to claim 1, wherein said base liquid is an edible base liquid and each of said additives is independently selected from a colorant, a flavoring, a sweetener, a pharmaceutical, a nutrient, a creamer, tea, coffee, an agent to promote mixing of said base liquid and said additive, a carbonating agent or a preservative.

3. The container according to claim 2, wherein said base liquid is water.

4. The container according to claim 2, wherein said base liquid is carbonated water and each of said additives is independently selected from a colorant, a flavoring, a sweetener, a pharmaceutical, a nutrient, an agent to promote mixing of said base liquid and said additive or a preservative.

5. The container according to claim 2, wherein said base liquid is a vegetable or meat broth and each of said additives is independently selected from a colorant, a flavoring, a pharmaceutical, a nutrient, an agent to promote mixing or a preservative.

6. The container according to claim 2, wherein said base liquid is a beverage.

7. The container according to claim 6, wherein said beverage is selected from a juice, a fruit drink, or a sports drink or a carbonated drink and each of said additives is independently selected from a colorant, a flavoring, a sweetener, a pharmaceutical, a nutrient, an agent to promote mixing of said base liquid and said additive, a carbonating agent or a preservative.

8. The container according to claim 7, wherein said base liquid is an unsweetened cola and said container comprises at least three different additive chambers wherein the first additive is a flavoring, the second additive is a sweetener and the third additive is caffeine.

9. The container according to claim 8, comprising a separate additive chamber for each of the additives: lemon flavoring, lime flavoring, cherry flavoring, vanilla flavoring, an artificial sweetener and caffeine.

10. The container according to claim 9, comprising two separate additive chambers for the additive caffeine.

11. The container according to claim 2, wherein at least a portion of said container is sufficiently transparent to allow visual confirmation of communication between said additive and said base liquid following the opening of said additive chamber.

12. The container according to claim 2, wherein said any of said additive chambers comprising a flavoring, a sweetener, a pharmaceutical, a nutrient, an agent to promote mixing of said base liquid and said additive, or a carbonating agent additionally comprises a colorant, wherein when said colorant is sufficient to perceptively alter the color of said base liquid when said additive is brought into liquid communication with said base liquid.

13. The container according to claim 2, comprising two or more separate additive chambers, wherein each chamber comprises a different flavoring additive and wherein each chamber further comprises a colorant typically associated with said flavoring additive.

14. The container according to claim 2, wherein said base liquid is selected from water, carbonated water, juice, fruit drink, sports drink or carbonated beverage and said flavoring additive is selected from vanilla, lemon, lime, cherry, orange, tangerine, banana, mango, papaya, grapefruit, black cherry, raspberry, strawberry, mixed berry, kiwi, root beer, or apple.

15. The container according to claim 6, wherein said beverage is tea and said flavoring additive is selected from apple, apricot, blueberry, chocolate, kiwi, strawberry, mint, orange, peach, cherry, tangerine, sassafras, raspberry, passion fruit, mango, lemon, lime, clove, black currant, cinnamon, cranberry, or papaya.

16. The container according to claim 6, wherein said beverage is coffee and said flavoring additive is selected from vanilla, hazelnut, mocha, chocolate, cinnamon, apricot, banana, blueberry, butter pecan, bourbon, caramel, cherry, mint, raspberry, coconut, rum, vanilla, frangelica, macadamia nut, rum, orange, pumpkin, chestnut, maple, white chocolate, pecan, butterscotch, almond, amaretto, hazelnut, mocha, chocolate, or cinnamon.

17. The container according to claim 5, wherein said flavoring additive is selected from salt, black pepper, hot pepper, garlic, onion, an herb, a spice.

18. The container according to claim 2, wherein said pharmaceutical is selected from caffeine, theophylline, a sleeping aid, an analgesic, an anti-inflammatory, a decongestant, a digestive, an antihistamine, an expectorant, a cough suppressant or an erectile dysfunction drug.

19. The container according to claim 2, wherein said sweetener is an artificial sweetener.

20. The container according to claim 19, wherein said artificial sweetener is selected from saccharine, cyclamate, aspartame, alitame, neotame, acesulfame-K, sucralose or Stevia.

21. The container according to claim 2, wherein said nutrient is selected from a vitamin, a mineral, an herbal extract, or a dietary supplement.

22. The container according to claim 11, wherein said base liquid is clear, said container comprising at least three separate additive chambers, wherein each of said three separate chambers comprises a different colorant.

23. The container according to claim 22, wherein said colorant additives comprise a red colorant, a blue colorant and a green colorant.

24. The container according to claim 23, comprising separate additive chambers for an orange colorant, a yellow colorant, and a violet colorant.

25. The container according to claim 11, wherein said base liquid is white, comprising at least three separate additive chambers, wherein the first of said additive chambers comprises a cyan colorant, the second of said additive chambers comprises a yellow colorant and the third of said additive chambers comprises a magenta colorant.

26. The container according to claim 2, wherein said preservative is selected from EDTA, BHT or benzoic acid.

27. The container according to claim 6, wherein said beverage is an alcoholic beverage.

28. The container according to claim 6, wherein said beverage is a dairy product or a pre-flavored dairy product.

29. The container according to claim 1, wherein said container is sterilely filled with a base liquid and sealed.

30. The container according to claim 29, wherein said base liquid is infant formula and each of said additives is independently selected from a colorant, a flavoring, a sweetener, a pharmaceutical, a nutrient, an agent to promote mixing of said base liquid and said additive, or a preservative.

31. The container according to claim 29, wherein said base liquid is intended for intravenous administration to a patient and wherein each of said additives is independently selected from a pharmaceutical, a nutrient, a salt or a sugar.

32. The container according to claim 1, wherein said base liquid is paint and each of said additive chambers comprises an independently selected additive that is a paint pigment or dye.

33. The container according to claim 29, wherein said base liquid is intended as media for cell growth, wherein each of said additive chambers comprises an independently selected additive selected from a metal, an amino acid, an antibacterial, an antifungal, an enzyme, a pharmaceutical, a pH-adjusting additive, a salt, a sugar, a color pH indicator, a nucleotide, a protein, an antibody, fluorescent probe, a radioactive probe, or a nutrient.

34. The container according to claim 1, wherein said base liquid is a perfume base and each of said additive chambers comprises an independently selected additive selected from a colorant or an essence.

35. The container according to claim 1, wherein said base liquid is a cosmetic and each of said additive chambers comprises an independently selected additive selected from a colorant, or an essence.

36. The container according to claim 1, wherein said base liquid is a hair coloring base and each of said additive chambers comprises an independently selected additive that is a hair dye colorant.

37. The container according to claim 1, wherein said base liquid is a cleaning agent base and each of said additive chambers comprises an independently selected additive selected from a bleaching agent, an essence, a concentrated cleaning agent, a grease cutting agent, ammonia, or a disinfectant.

38. The container according to claim 1, wherein said base liquid is a disinfecting agent base and each of said additive chambers comprises an independently selected additive selected from a bleaching agent, an essence, a cleaning agent, a grease cutting agent, ammonia, or a concentrated disinfecting agent.

39. The container according to claim 1, wherein said base liquid is an emollient and each of said additive chambers comprises an independently selected additive selected from an essence, a coloring agent, an ultra-violet light blocking agent, a nutrient, or an insect repellant.

40. The container according to claim 1, wherein at least a portion of the outer chamber surface of each of said additive chambers is in physical communication with the main chamber of said vessel.

41. The container according to claim 1, wherein at least a portion of the outer chamber surface of each of said additive chambers is in physical communication with the outer vessel surface.

42. The container according to claim 1, wherein each of said additive chambers additionally comprises integrated means for opening said chamber.

43. The container according to claim 1, additionally comprising means for opening each of said additive chambers, wherein said means for opening said chamber is not in physical communication with said chamber.

44. The container according to claim 1, wherein each of said additive chambers opens into physical communication with said main vessel chamber upon the application of physical pressure upon the outer chamber surface by said user.

45. The container according to claim 1, further comprising a mixing chamber positioned between said main chamber and said outlet, wherein said main chamber is connected to said mixing chamber by one-way closing means which allows unidirectional flow of said base liquid from said main chamber to said mixing chamber, and wherein each of said additive chambers, when opened, is in communication with said mixing chamber.

46. The container according to claim 44, wherein said additive chambers are blister packs.

47. The container according to claim 44, wherein said additive chambers are comprised of gas-filled polyethylene.

48. The container according to claim 42, wherein said integrated means is a plunger device contained within said additive chamber.

49. The container according to claim 42, wherein said integrated means is piezoelectric means.

50. The container according to claim 42, wherein said integrated means is a piercing device.

51. The container according to claim 42, wherein the quantity of additive released from any one additive chamber and placed in communication with said base liquid is user-adjustable.

52. The container according to claim 2, wherein the opening of said additive chamber is controlled by a switch, a lever or a valve.

53. The container according to claim 42, wherein said integrated means is a piston.

54. The container according to claim 53, wherein said additive chamber is a syringe.

55. The container according to claim 1, wherein the additive chamber is a raised hollow flexible button present on the outer vessel surface.

56. The container according to claim 55, wherein the additive chamber is in communication with and seals an aperture in said vessel, and wherein the seal between said additive chamber and said aperture is selected from a detachable plug or a breakable liquid impermeable barrier.

57. The container according to claim 56, wherein said liquid impermeable barrier is contiguous with said inner vessel surface and contains weakening lines at said aperture.

58. The container according to claim 1, wherein said additive is a dissolvable solid.

59. The container according to claim 58, wherein said additive is selected from a tablet, a disc, a bar, a powder, microspheres, nanospheres, crystals, flakes, or a sheet.

60. The container according to claim 60, wherein said additive is particulate and said particles are size distributed for even distribution when in communication with said base liquid.

61. The container according to claim 1, wherein said additive is a miscible liquid.

62. A programmable liquid container comprising:
a vessel having a main chamber fillable with a base liquid, an inner vessel surface in physical communication with said main chamber, a sealable outlet, and a sealing device for sealing said outlet; and
a plurality of different additives sealed independently or multiply within a plurality of additive chambers, each additive chamber having an inner chamber surface and an outer chamber surface, wherein:
said outer additive chamber surface is in physical communication with said sealing device;
said additive chamber is manually openable by a user when said vessel is filled with a base liquid and said outlet is sealed, and wherein opening an additive chamber places any additive contained therein in communication with said base liquid prior in said vessel and wherein said opening does not disrupt the integrity of the sealed vessel; and
when said base liquid is an edible base liquid and one of said additive chambers comprises an additive that is a colorant, at least one other of said additive chambers comprises an additive other than a colorant.

63. A disposable liquid container comprising a vessel having a main chamber fillable with a base liquid and an inner vessel surface in physical communication with said main chamber, wherein at least a portion of said inner surface that can be brought into communication with said base liquid is coated with an additive selected from a colorant, a flavoring, a sweetener, a pharmaceutical, a nutrient, a creamer, tea, or coffee, wherein said additive is soluble in said base liquid.

64. A disposable utensil intended to be brought into communication with a base liquid, said utensil comprising an outer surface, wherein said outer surface is coated with an additive selected from a colorant, a flavoring, a sweetener, a pharmaceutical, a nutrient, a creamer, tea, coffee, wherein said additive is soluble in said base liquid.

65. The utensil according to claim 64, wherein said utensil is a spoon or a stirrer.

66. The utensil according to claim 65, wherein said utensil consists of materials that are soluble in said base liquid.

67. A single composition of matter comprising a plurality of additives to be added to a base liquid, wherein:
said plurality comprises at least three different additives independently selected from a colorant, a flavoring, a sweetener, a pharmaceutical, a nutrient, a creamer, tea, coffee, an agent to promote mixing of said base liquid and said additive, a carbonating agent or a preservative; and
each additive is manually separable from another by a user.

68. The container according to claim 1 additionally comprising an LCD display.

69. The container according to claim 68, wherein said LCD display is a temperature indicator.

70. The container according to claim 68, wherein said LCD display indicates to the user an additive chamber has been opened.

71. The container according to claim 1, additionally comprising a device for heating or cooling said base liquid prior to said base liquid exiting said outlet.

72. The container according to claim 1, wherein said additive is sealed in said additive chamber under an inert gas.

73. The container according to claim 1, wherein said additive chambers are arranged in a grid-like array.

74. The container according to claim 73, wherein the same additive is present in a plurality of chambers, wherein said plurality of chamber comprising the same additive is aligned in a row or a column of said grid.

75. The container according to claim 74, wherein each of the plurality of chambers comprising the same additive comprises a different quantity or concentration of said same additive.

76. The container according to claim 75, wherein the quantity or concentration of said same additive is 1× in a first of said plurality of chambers, 2× in a second of said plurality of chambers, 4× in a third of said plurality of chambers and if said plurality of chambers is greater than three, twice as much as the preceding chamber in each of the subsequent chambers comprising the same additive.

77. The container according to claim 76, wherein the base liquid is a white or colorless paint; and the container comprises a 4 by 4 array of additive chambers comprising the colorants cyan, yellow, magenta and black.

78. The container according to claim 1, additionally comprising a structure for facilitating the mixing of said additive and said base liquid, wherein said structure is in communication with said main chamber.

79. The container according to claim 1, wherein said additive chamber is pressurized.

80. A method of providing improved personalized beverage selection from a vending machine comprising the steps of:
stocking said vending machine with a plurality of bottles filled with the same base liquid;
stocking said vending machine with a plurality of separately packaged additives comprising at least four different individually packaged flavoring additives; and
offering for sale from said vending machine in a single purchase a bottle of said base liquid and a choice of one of said flavoring additive packages.

81. The method according to claim 80, wherein a portion of each of said flavoring additive packages additionally comprises caffeine.

82. The method according to claim 80, wherein a first portion of each of said flavoring additive packages additionally comprises an artificial sweetener and a second portion of each of said flavoring additive packages comprises a natural sweetener.

83. A personalized beverage vending machine comprising:
storage space for a plurality of bottles filled with the same base liquid; and
storage space for a plurality of separately packaged additives, wherein said vending machine comprises selection means to allow a user to choose at least one of said additives in a single purchase; and wherein upon said purchase and said choice of additive, said machine provides said user with a bottle of said base liquid and the at least one selected additive package.

84. The container according to claim 1, wherein said additive chamber comprises a liquid permeable inner chamber permanently affixed to the inner surface of said additive chamber, wherein said additive is within said inner chamber.

85. A kit consisting essentially of:
at least one container filled with an edible base liquid;
a plurality of additives to be added to the base liquid, wherein said plurality of additives comprises at least three additives independently selected from a colorant, a flavoring, a sweetener, a pharmaceutical, a nutrient, a creamer, tea, coffee, an agent to promote mixing of said base liquid and said additive, a carbonating agent or a preservative; and
a holder for holding said container and said plurality of additives together in a single portable package.

86. The kit according to claim 85, wherein said plurality of additives is a single composition of matter.

87. A programmable liquid container comprising:
a vessel having a main chamber fillable with a base liquid, an inner vessel surface in physical communication with said main chamber, an outer vessel surface, and a plurality of sealable outlets; and
a plurality of sealed additive chambers corresponding in number to the number of sealable outlets, each sealed additive chamber being in communication with one of said outlets and each sealed additive chamber comprising an independently selected additive, wherein:
each additive chamber is openable by a user when said vessel is filled with a base liquid by inserting a piercing device through an outlet into the vessel to open said outlet; and opening an additive chamber associated with said opened outlet by inserting said piercing device through said opened outlet, wherein opening an additive chamber places any additive contained therein in communication with said base liquid prior in said vessel.

88. The container according to claim 87, wherein said base liquid is an edible base liquid.

89. The container according to claim 87, wherein said edible base liquid is a fruit juice.

90. The container according to claim 87, wherein said piercing device is a piercing straw.

91. The container according to claim 87, wherein an outlet is in communication with an additive chamber through a conduit.

92. The container according to claim 1, wherein said vessel is filled with a base liquid and is sealed under pressure and wherein the force required to open any of said additive chambers prior to releasing said pressure is selected from at least 1.1, 1.2, 1.3, 1.4 or 1.5 times greater than the force that can be generated by the finger of an average five-year old.

93. The container according to claim 92, wherein the force required to open any of said additive chambers prior to releasing said pressure is selected from at least 1.1, 1.2, 1.3, 1.4 or 1.5 times greater than the force that can be generated by the finger of an average adult male.

94. The container according to claim 92 or 93, wherein the force required to open any of said additive chambers after releasing said pressure is less than the force that can be generated by the finger of an average five-year old.

95. The container according to claim 1, wherein said additive is a liquid additive in a frangible holder, wherein said frangible holder is present in said additive chamber.

96. The container according to claim 95, wherein at least a portion of an inner wall of said additive chamber comprises a rigid region that provides sufficient resistance to cause release of the additive from the frangible holder, when the frangible holder is pressed against said rigid region with sufficient manual force.

97. The container according to claim 95, wherein at least a portion of an inner wall of said additive chamber comprises jagged or pointed elements that cause the frangible holder to release the additive container therein when said frangible holder contacts said inner wall portion under manual force.

98. A method of manufacturing a container according to claim 55 comprising the steps of:
a. providing a flexible outer portion of said container, wherein said outer portion comprises outward protrusions that define a portion of an additive chamber in the final assembled container and that corresponds in shape to at least a portion of the final assembled container;
b. providing an inner portion of less flexibility than said outer portion, wherein said outer portion corresponds in shape to the whole container;
c. fitting said outer portion over said inner portion; and
d. fusing said inner portion to said outer portion.

99. The method according to claim 98, wherein said inner portion additionally comprises apertures align with at least a portion of the outward protrusions when the inner portion and outer portion are fused to one another.

100. The method according to claim 98, wherein said inner portion additionally comprises an element that is capable of opening when manual pressure is applied to the outer protrusion in the assembled container.

101. The method according to claim 98, comprising the additional step filling said additive chambers with one or more additives.

102. The method according to claim 99, comprising the additional steps of:
e. filling said additive chambers with one or more additives from the inside of said container through said apertures; and
f. sealing said apertures.

103. A method of manufacturing a container according to claim 1, wherein said container comprises a top portion, a body portion, and means for applying sufficient pressure to an additive chamber to cause said chamber to open and release the additive container therein into a base liquid contained in said container, wherein said top portion and body portion are fused to one another to create said container, said method comprising the steps of:
a. providing a top portion having an inside surface and an outside surface and plurality of open additive chambers attached to said inside surface;
b. filling said additive chambers with an independently selected additive;
c. sealing said additive chambers; and
d. fusing said top portion to a body portion to form said container.

104. The container according to claim 55, wherein the additive is a liquid and wherein said additive is released from the additive chamber through an opening of a sufficiently small diameter to create a stream.

105. The container according to claim 55, wherein the additive is a liquid and wherein said additive is released through an opening located in the bottom third of the additive chamber.

106. The container according to claim 55, wherein said plurality of additive chambers are radially arranged around a circumference of said container.

107. The container according to claim 106, wherein said container is a bottle comprising an outlet having a first circumference and a midsection having a second circumference, wherein said second circumference is greater than said first circumference and wherein said additive chambers are located between said outlet and said midsection.

108. The container according to claim 107, wherein said additive chambers are located on a portion of the bottle having a circumference greater than the first circumference and less than the second circumference.

109. A method of manufacturing a container according to claim 55 comprising the steps of:
a. providing at least a portion of said vessel, wherein said portion comprises an outward protrusion on its surface; and
b. affixing a membrane on an inner surface of said vessel portion so as to block communication between said protrusion and said interior space of said vessel portion, thus forming a chamber defined by said protrusion and said membrane.

110. The method according to claim 109, wherein said protrusion is filled with an additive prior to affixing said membrane on said inner surface of said vessel portion.

111. A method of manufacturing a container according to claim 55 comprising the steps of:
a. providing an additive chamber element, said element comprising a flange portion and a convex portion;
b. affixing said flange portion of said chamber element to the outer surface of said vessel, so as to form an additive chamber defined by the convex portion of said additive chamber element and the outer surface of said vessel.

112. The method according to claim 111, wherein said vessel additionally comprises an aperture that aligns with at least a portion of the convex portion of said element when the flange of said element is affixed to the outer surface of said vessel.

113. A sealed chamber comprising, an additive within the chamber to be mixed with a base liquid when the chamber is opened and an integrated device to open the chamber, wherein the additive chamber is in physical communication with a vessel comprising the base liquid.

114. The sealed chamber of claim 113, wherein the integrated device is a pump.

115. The sealed chamber of claim 113, wherein the base liquid is water.

116. The sealed chamber of claim 113, wherein the additive is a flavoring.
